(19) United States
(12) Patent Application Publication
(10) Pub. No.: US 2026/0152055 A1
(43) Pub. Date: Jun. 4, 2026

(54) Off-Road Vehicle

(71) Applicant: Zhejiang CFMOTO Power Co., Ltd., Hangzhou (CN)

(72) Inventors: Haihong Chen, Hangzhou (CN); Dong Ding, Hangzhou (CN); Jia Li, Hangzhou (CN); Feng Lou, Hangzhou (CN); Zhongye Jiao, Hangzhou (CN); Lufeng Yang, Hangzhou (CN)

(21) Appl. No.: 19/461,639

(22) Filed: Jan. 27, 2026

Related U.S. Application Data
(63) Continuation of application No. PCT/CN2024/107100, filed on Jul. 23, 2024.

(30) Foreign Application Priority Data
Jul. 28, 2023 (CN) 202310942531.1

(51) Int. Cl. B60K 6/46; B60K 6/28; B60K 6/40; B60K 6/50; B60K 11/04; B60N 2/20; B60N 3/10

(52) U.S. Cl. CPC B60K 6/46; B60K 6/28; B60K 6/40; B60K 6/50; B60K 11/04; B60N 2/20; B60N 3/104

(57) ABSTRACT

Off-road vehicle includes a frame, wheels, a locomotive power system, and a drive train. The frame includes a rear frame positioned at the rear of the frame, and the rear frame defines a receiving space. The wheels supports under the frame and includes front wheels and rear wheels. The locomotive power system includes a drive motor for driving the wheels and a range extender for outputting electrical energy to provide energy for the drive motor. When viewed from a width direction of the off-road vehicle, the drive motor overlaps at least partially with the range extender; when viewed from a length direction of the off-road vehicle, the drive motor overlaps at least partially with the range extender, and the drive motor is at least partially positioned behind the range extender. This arrangement can make the off-road vehicle more compact. longitudinal midplanelongitudinal midplanelongitudinal midplanelongitudinal midplane

### RELATED APPLICATION INFORMATION

The present application is a continuation of PCT/CN 2024/107100 filed Jul. 23, 2024 and entitled “All-Terrain Vehicle”, and claims the benefit of priority to Chinese Patent Application No. 202310942531.1, entitled “All-Terrain Vehicle”, filed with the Chinese Patent Office on Jul. 28, 2023. The entire contents of the above-referenced applications are incorporated herein by reference.

### FIELD OF THE DISCLOSURE

The present invention relates to the field of vehicles, and particularly to an off-road vehicle.

### BACKGROUND OF THE DISCLOSURE

An off-road vehicle is a four-wheel vehicle that operates in all weather and all terrain conditions. Some hybrid off-road vehicles have a combination of energy supply components of both fuel and electric off-road vehicles, such as range extenders, drive motors, power batteries, and the like. The spatial layout requirements for structural compactness of hybrid off-road vehicles which have range extenders are high. The handling stability, driving safety, and riding comfort of the entire vehicle are also closely related to the structural compactness of such off-road vehicles. However, existing hybrid off-road vehicles with range extenders do not achieve optimized structure compactness. Better solutions are needed.

### SUMMARY OF THE INVENTION

The present embodiment provides an off-road vehicle to solve at least one problem existing in the background.

In a first aspect, an off-road vehicle includes a frame, a locomotive power system, seating and wheels. The frame includes a rear frame which defines a rear receiving space. The locomotive power system is supported by the frame at least partially positioned in the rear receiving space. The locomotive power system includes an electric drive motor for providing torque and a range extender for outputting electrical energy. The seating is mounted on the frame in front of the locomotive power system. The seating includes front-row seating and rear-row seating. The rear-row seating includes a moveable lower backrest. The wheels support the frame and are driven by torque from the electric drive motor. The wheels include front wheels in front of the seating and rear wheels behind the seating. The drive motor overlaps at least partially with the range extender in side view. Additionally, the drive motor is positioned at least partially rearward of the range extender. The range extender overlaps at partially with the moveable lower backrest in front view. The amount of front view overlap of the range extender and the moveable lower backrest is in a range from 627 cm² to 941 cm².

In a second aspect, the range extender and the drive motor are substantially arranged on opposing right or left sides of the longitudinal mid-plane of the off-road vehicle.

In a third aspect, the off-road vehicle further includes a power battery mounted on the frame at least partially under the seating. The power battery has a power battery length. A wheelbase is defined as the longitudinal distance between the axis of the front wheels and the axis of the rear wheels. The power battery length is in a range of 17 to 34% of the wheelbase. A longitudinal distance between the axis of the front wheels and a front-most end of the power battery is defined as a front axis-battery gap. A longitudinal distance between a rear-most end of the power battery and the axis of the rear wheels is defined as a battery-rear axis gap. A battery gap ratio of the front axis-battery gap to the battery-rear axis gap is in a range from 0.61 to 1.14.

Details of several embodiments are presented in the following figures and description to make other features, objectives, and advantages more concise and understandable.

### BRIEF DESCRIPTION OF THE DRAWINGS

FIG. 1 is a front left perspective view of a preferred off-road vehicle of the present invention.

FIG. 2 is a rear left perspective view, from below, of the frame and locomotive power system of the off-road vehicle of FIG. 1.

FIG. 3 is a top plan view of the rear frame, locomotive power system, intake system and exhaust system of the off-road vehicle of FIG. 1.

FIG. 4 is a left side view of the frame and seating of the off-road vehicle of FIG. 1.

FIG. 5 is a front left exploded perspective view, from below, of part of the frame, the power battery, and the skidplate of the off-road vehicle of FIG. 1.

FIG. 6 is rear left exploded perspective view, from above, of the power battery of FIGS. 4 and 5.

FIG. 7 is a rear view of a partial structure of the off-road vehicle of FIG. 1.

FIG. 8 is a front left exploded perspective view, from above, of a portion of the frame, the rear-row seating, an alternative range extender, and an alternative air intake system which can be used in the off-road vehicle of FIG. 1.

FIG. 9 is a left side view of the frame, range extender, front left wheel and alternative rear-row seating which can be used in the off-road vehicle of FIG. 1.

FIG. 10 is an enlarged view of section 10 of FIG. 9.

FIG. 11 is the top plan view of FIG. 3, calling out further aspects of the rear frame, locomotive power system, intake system and exhaust system.

FIG. 12 is a left side view of the range extender, exhaust system, and CDU module of the off-road vehicle of FIG. 1.

FIG. 13 is a top plan view of the drive motor, CDU module, and motor controller of the off-road vehicle of FIG. 1.

FIG. 14 is a rear left perspective view of the rear-row seating and portions of the upper bracket of the off-road vehicle of FIG. 1.

FIG. 15 is a top perspective view of the rear-row seating of FIG. 14 in a folded position, also showing portions of the frame and cargo container of the off-road vehicle of FIG. 1.

FIG. 16 is an enlarged view of section 16 in FIG. 15.

FIG. 17 is a rear right perspective view, from above, of the rear-row seating of FIG. 14 with the multiple person rear-row seating in the folded position.

FIG. 18 is a left side view, in partial cross-section, of the armrest frame and connection structure of FIGS. 15 and 17.

FIG. 19 is a top plan view of portions of the frame and the locomotive power system of the off-road vehicle of FIG. 1.

FIG. 20 is an exploded perspective view of one of the hangers of FIG. 19.

FIG. 21 is a side view of the hanger of FIG. 20.

FIG. 22 is a rear right perspective view of the frame and rear suspension of the off-road vehicle of FIG. 1.

FIG. 23 is a rear right perspective view of the rear control arm support section portion of the frame shown in FIG. 22.

FIG. 24 is a perspective view of one of the control arm connection seats of FIGS. 22 and 23.

FIG. 25 is a front left perspective view of the front frame, air conditioner, and a portion of the cooling system of the off-road vehicle of FIG. 1.

FIG. 26 is a left side view of the front frame, air conditioner, and portion of the cooling system of FIG. 25.

FIG. 27 is a front left perspective view of the power battery, drive combination unit, and cooling system of the off-road vehicle of FIG. 1.

FIG. 28 is left side view of a portion of FIG. 26, also showing a schematic view of the air outlet mechanism of the air conditioner.

FIG. 29 is a left side schematic view of the air outlet mechanism of FIG. 28.

FIG. 30 is an end view of the air outlet mechanism of the FIGS. 28 and 29.

FIG. 31 is a rear left perspective view of the dashboard control panel and collection of composite panels of the off-road vehicle of FIG. 1.

### DETAILED DESCRIPTION

In order to enable personnel in this field to better understand the present invention, the technical solutions in the specific embodiments of the present invention will be clearly and completely described below in conjunction with the accompanying drawings.

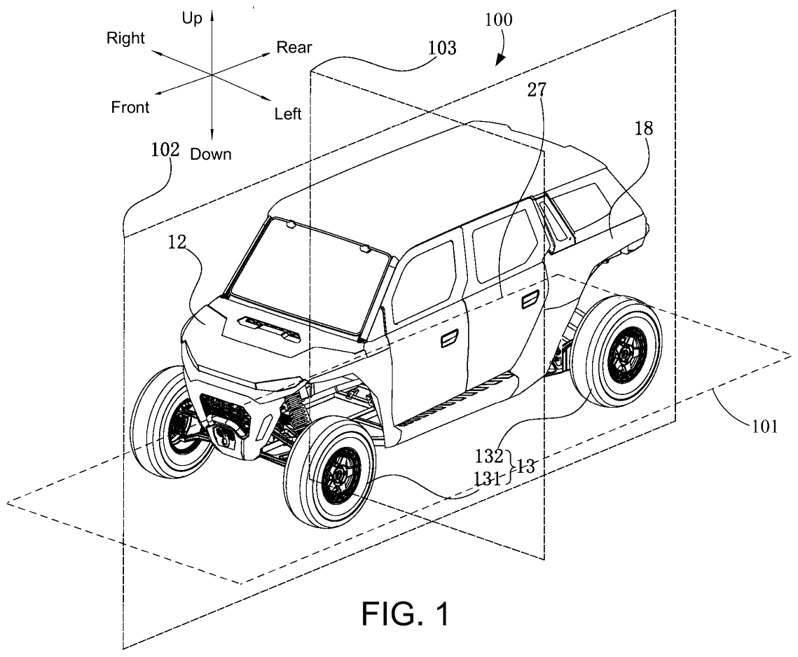

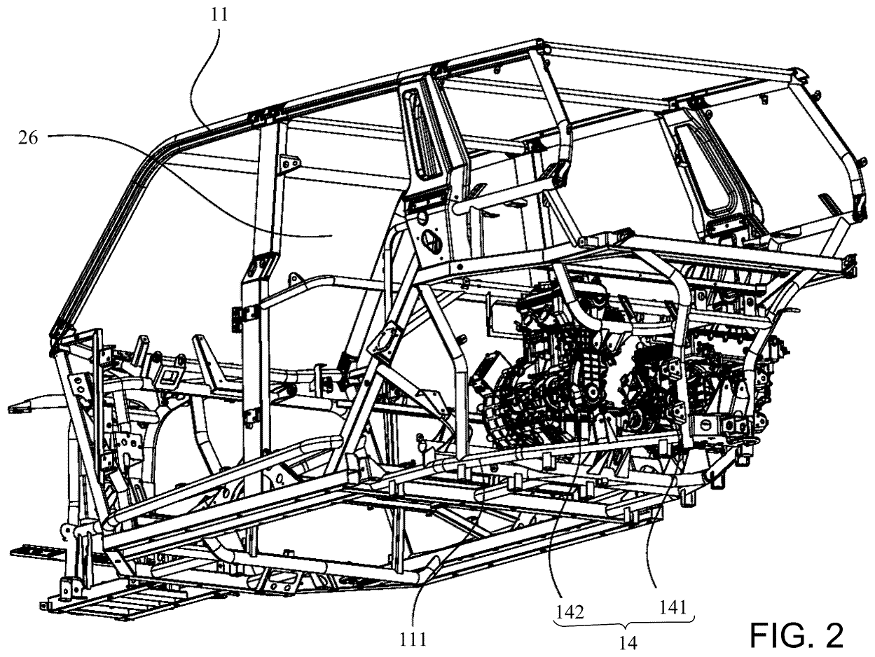

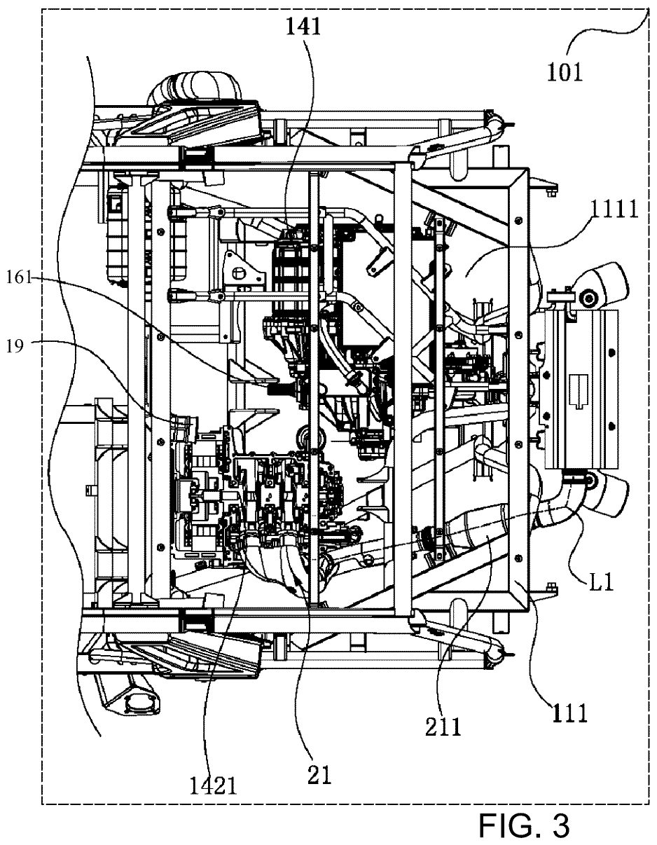

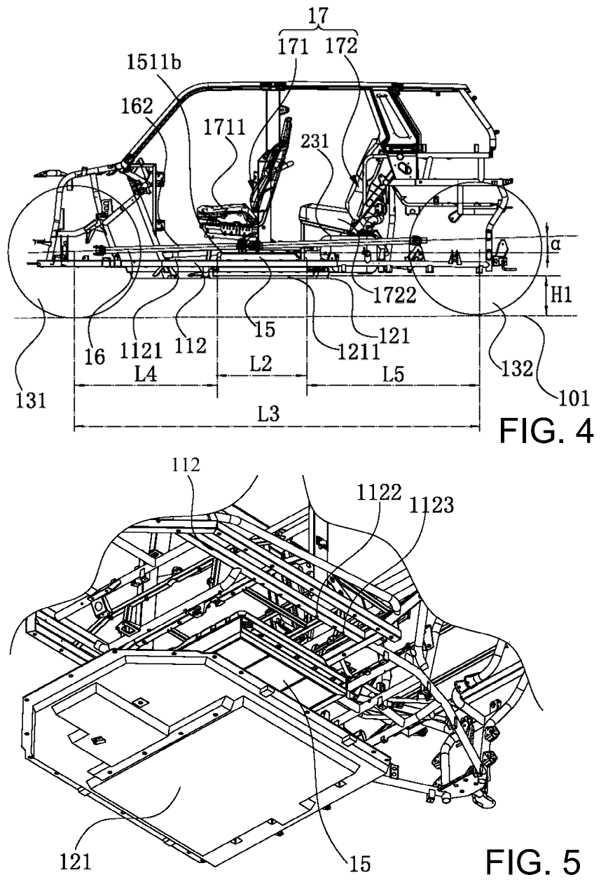

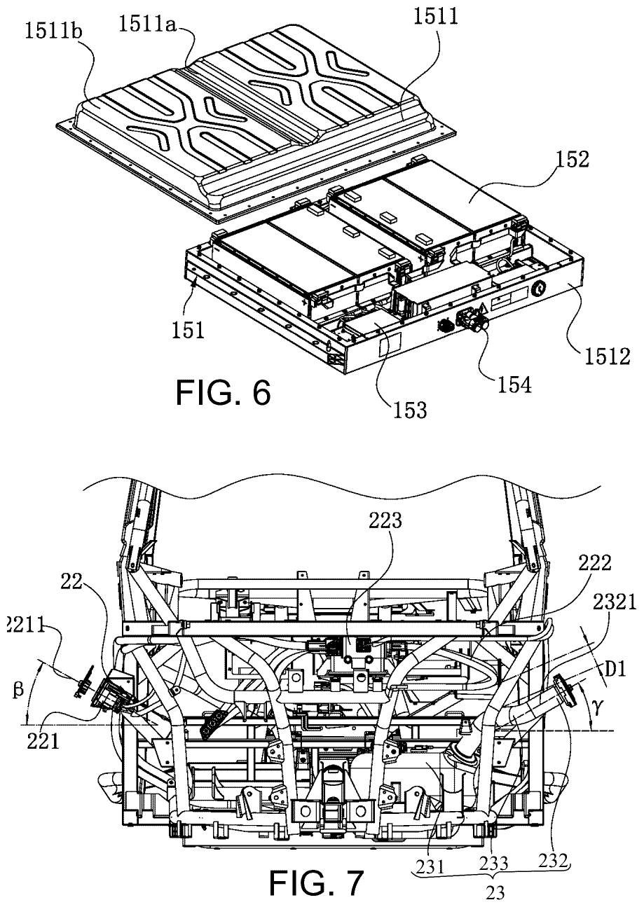

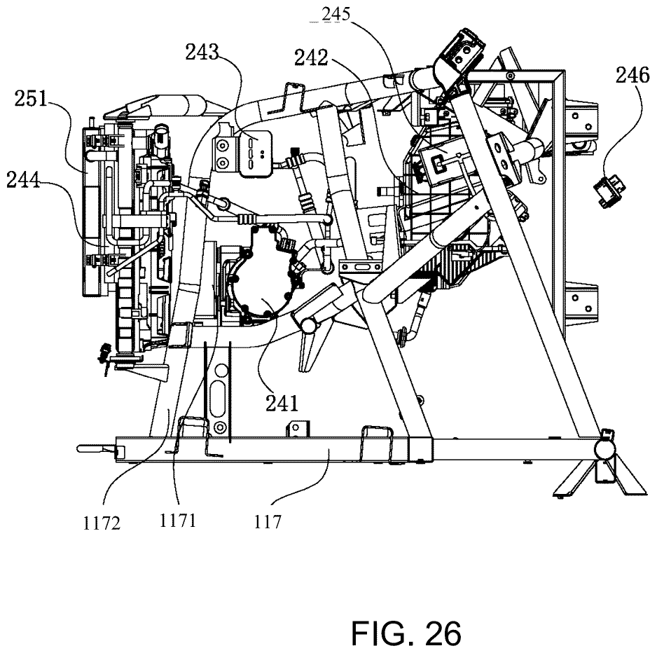

As shown in FIGS. 1 to 4, an off-road vehicle 100 includes a frame 11, a vehicle body cover 12, wheels 13, a locomotive power system 14, a power battery 15, a drive train 16, seating 17, and a cargo container 18. As the basic framework of the off-road vehicle 100, the frame 11 is used to carry the vehicle body cover 12, the wheels 13, the locomotive power system 14, the power battery 15, the drive train 16, the seating 17, and a cargo container 18. The vehicle body cover 12 is at least partially mounted on the frame 11 to protect internal components of the off-road vehicle 100. The wheels 13 are positioned at least partially below the frame 11, and include front wheels 131 and rear wheels 132 defining a wheelbase L3 as called out in FIG. 4. The locomotive power system 14 is supported by the frame 11, and includes a drive motor 141 connected to the front wheels 131, the rear wheels 132, or more preferably both the front wheels 131 and the rear wheels 132 through the drive train 16, so that the drive motor 141 can drive the off-road vehicle 100 to move. The power battery 15 is at least partially mounted on the frame 11 and provides electricity for the drive motor 141. The seating 17 is at least partially mounted on frame 11 to provide support for the driver and passengers. The cargo container 18 is at least partially positioned on a rear frame 111 of the frame 11, and is used for carrying cargo on off-road vehicle 100. The rear frame 111 defines a rear receiving space 1111 for the locomotive power system 14. In addition to the rear frame 111, the frame 11 also includes a middle frame 112 and a front frame 117 (called out in FIGS. 25 and 26). The directions front, rear, left, right, up and down are also shown in FIG. 1. In this specification, the terms “longitudinal” and “length” generally refer to the front-rear direction of the off-road vehicle 100, the terms “width”, “transverse” and “cross” generally refer to the left-right direction of the off-road vehicle 100, and the terms “height” and “vertical” generally refer to the up-down direction of the off-road vehicle 100.

As shown in FIG. 1, a ground plane 101 is defined as being perpendicular to the height direction of the off-road vehicle 100 at the bottoms of the wheels 13. A longitudinal midplane 102 is defined as being perpendicular to the width direction of the off-road vehicle 100 along a centerline of the vehicle 100. A transverse plane 103 is defined as being perpendicular to the length direction of the off-road vehicle 100, half way between the front edge and the rear edge of the vehicle 100.

In addition to the drive motor 141, the locomotive power system 14 includes a range extender 142. The range extender 142 is a relatively small internal combustion engine, the torque output of which is not directly provided to the drive train 16, but instead powers a generator, dynamo or alternator to provide additional electricity for charging the power battery 15 and/or for the drive motor 141, thereby increasing the range of the vehicle 100 and reducing “range anxiety”, offering an electric driving experience with backup fuel capability. The drive motor 141 and the range extender 142 are both at least partially arranged in the rear receiving space 1111.

The combined plan view area of the range extender 142 and the drive motor 141 (i.e., the area of a projection of the range extender 142 along the height direction of the off-road vehicle 100 on the ground plane 101 plus the area of a projection of the drive motor 141 along the height direction of the off-road vehicle 100 on the ground plane 101) preferably occupies from 26 to 49% of the plan view area of the rear receiving space 1111. Both the range extender 142 and the drive motor 141 have outer shells, and the combined plan view area of the range extender 142 and the drive motor 141 is the total projection of the outer shells of the range extender 142 and the drive motor 141 along the height direction of the off-road vehicle 100 on the ground plane 101. That is to say, the combined plan view area of the range extender 142 and the drive motor 141 does not include contributions of wiring harnesses and other peripheral structures on the range extender 142 and the drive motor 141, but only includes the projection of the main bodies of the range extender 142 and the drive motor 141. More preferably, the combined plan view area of the range extender 142 and the drive motor 141 occupies from 30 to 42% of the plan view area of the rear receiving space 1111, and most preferably the combined plan view area of the range extender 142 and the drive motor 141 is 37% of the plan view area of the rear receiving space 1111. These preferred ratios of plan view areas are beneficial for arrangement of other components of the off-road vehicle 100 while meeting the arrangement requirements of the range extender 142 and the drive motor 141.

In side view, the drive motor 141 overlaps at least partially with the range extender 142, with the drive motor 141 preferably at least partially positioned rearwardly relative to the range extender 142. The side view overlap of the drive motor 141 and the range extender 142 is preferably in the range from 402 cm² to 605 cm², more preferably in the range from 453 cm² to 554 cm², and most preferably about 503 cm². Having the amount of side view overlap between the drive motor 141 and the range extender 142 within these preferred ranges ensures compact arrangement of the drive motor 141 and the range extender 142 while reducing the influence of high temperature of the range extender 142 on the drive motor 141 and on other components.

In the depicted embodiment, the drive motor 141 is substantially on the right side of the off-road vehicle 100, and the range extender 142 is substantially on the left side of the off-road vehicle 100. Alternatively, the drive motor 141 could be on the left with the range extender 142 on the right. Either way, the center of gravity of the drive motor 141 and the center of gravity of the range extender 142 are on opposite sides of the longitudinal midplane 102, so that the weights of the drive motor 141 and the range extender 142 are more balanced on the off-road vehicle 100, improving driving stability.

The off-road vehicle 100 includes an air intake system 19 providing air to the intake duct/manifold of the range extender 142 for combustion and an exhaust system 21 discharging exhaust gas from an exhaust manifold 1423 of the range extender 142 after combustion. The range extender 142 is preferably oriented with its crankshaft 1421 extending longitudinally in the off-road vehicle 100, with the air intake system 19 toward the longitudinal midplane 102 near the drive motor 141 and with the exhaust system 21 on the outside of the off-road vehicle 100, away from the longitudinal mid-plane and away from the drive motor 141. This orientation shortens the length of exhaust system 21 while keeping heat of the exhaust system 21 away from the drive motor 141. The exhaust system 21 includes an exhaust pipe 211 with an exhaust pipe length L1. The exhaust pipe length L1, measured along the movement direction of exhaust gas, is preferably in the range from 800 mm to 1300 mm, and most preferably about 1031 mm.

The middle frame 112 is arranged between the front wheels 131 and the rear wheels 132 supporting the seating 17 as called out in FIG. 4. The middle frame 112 defines a battery receiving space 1121, and the power battery 15 is arranged in the battery receiving space 1121 at least partially below the seating 17. The seating 17 includes at least one row of seats and more preferably front row seating 171 and rear row seating 172. The length of the power battery 15 is preferably longer than the length of at least one row 171 or 172 of seating 17. The plan view area of the power battery 15 preferably occupies from 34 to 65% of the plan view area of the seating 17, more preferably from 41 to 57% of the plan view area of the seating 17, and most preferably about 49% of the plan view area of the seating 17. The plan view area of the seating 17 refers to the total projection of the seat cushions of all seats of seating 17 along the height direction of the off-road vehicle 100 on the ground plane 101. These preferred ratios of plan view area of the power battery 15 to plan view area of the seating 17 allow best space utilization while meeting the layout requirements of the off-road vehicle 100 and preventing the relative position of the power battery 15 from affecting the driving experience of the driver and/or passengers.

The front-row seating 171 includes a front-row seat bottom cushion 1711, and the rear-row seating 172 includes a rear-row seat bottom cushion 1722. The plan view area of the front-row seat bottom cushion 1711 preferably occupies from 24 to 47% of the plan view area of the power battery 15, more preferably from 30 to 42% of the plan view area of the power battery 15, and most preferably about 36% of the plan view area of the power battery 15. The plan view area of the rear-row seat bottom cushion 1722 preferably occupies from 10 to 18% of the plan view area of the power battery 15, more preferably from 12 to 16% of the plan view area of the power battery 15, and most preferably about 14% of the plan view area of the power battery 15. These plan view area ratios minimize the influence of the power battery 15 on the arrangement of brake, throttle and other components on the front side of front-row seating 171, as well as the influence of the power battery 15 on the arrangement of the locomotive power system 14 and other components behind the rear-row seating 172.

The power battery 15 has a power battery length L2. The power battery length L2 is preferably 17 to 34% of the wheelbase L3, more preferably 21 to 30% of the wheelbase L3, and most preferably about 26% of the wheelbase L3. The longitudinal distance between the axis of the front wheels 131 and the front-most end of the power battery 15 is defined as a front axis-battery gap L4. The longitudinal distance between the rear-most end of the power battery 15 and the axis of the rear wheels 132 is defined as a battery-rear axis gap L5. A battery gap ratio L4/L5 of the front axis-battery gap L4 to the battery-rear axis gap L5 is preferably in the range from 0.61 to 1.14, more preferably in the range from 0.74 to 1, and most preferably about 0.88. If the power battery length L2 is too small, it will affect the capacity of the power battery 15, resulting in a decrease in the range of the off-road vehicle 100. If the power battery length L2 is too large, or if the battery gap ratio L4/L5 is too large or too small, it will interfere with the front wheels 131 and the front components of the off-road vehicle 100, and/or interfere with the rear wheels 132 and the rear components of the off-road vehicle 100.

As shown in FIGS. 4 and 5, the vehicle body cover 12 includes a skidplate 121 below the power battery 15 to protect the power battery 15. The skidplate 121 is connected to the middle frame 112 and defines a heat dissipation space 1211. The power battery 15 is at least partially arranged in the heat dissipation space 1211. The heat dissipation space 1211 is in fluid communication with outside air, so that during the driving process of the off-road vehicle 100, air can flow through the heat dissipation space 1211, thereby cooling the power battery 15 for more stable operation of the power battery 15.

Several battery connection bolt holes 1122 are defined on the lower side of the middle frame 112, and the power battery 15 is fixedly connected to the middle frame 112 through the battery connection bolt holes 1122. The power battery 15 can be installed from the lower side of the off-road vehicle 100 to the middle frame 112, thereby improving the convenience of disassembling and assembling the power battery 15 without disassembling other components.

The bottom of the power battery 15 is preferably positioned below the lowest end of the middle frame 112, thereby lowering the center of gravity of the off-road vehicle 100 and improving its driving stability and controllability. The battery clearance height H1 between the power battery 15 and the ground plane 101 as called out in FIG. 4 is preferably in the range from 220 mm to 420 mm, more preferably in the range from 270 mm to 370 mm, and most preferably about 320 mm. With a battery clearance height H1 in the preferred range, the off-road vehicle 100 maintains good driving stability and maneuverability with adequate obstacle passability, thus meeting the driving needs of the off-road vehicle 100 on complex terrains.

The drive train 16 includes a gear reduction unit 161 receiving torque from the drive motor 141 and a front drive shaft 162 receiving torque from the gear reduction unit 161. The gear reduction unit 161 reduces the rotational speed from the output shaft (not separately shown) of the drive motor 141 to the front drive shaft 162. The gear reduction unit 161 is at least partially arranged between the drive motor 141 and the range extender 142, thereby improving the structural compactness of the locomotive power system 14 and the drive train 16.

The upper surface 1511b of the power battery 15 is preferably generally horizontal but defines a drive shaft avoidance recess 1511a. The drive shaft avoidance recess 1511a extends under the front drive shaft 162 to avoid interference with the front drive shaft 162. The drive shaft avoidance recess 1511a allows the overall space occupied by the power battery 15 and the front drive shaft 162 to be more compact.

The preferred off-road vehicle 100 places the axis of the front wheels 131 at the same elevation as the axis of the rear wheels 132, while the front drive shaft 162 preferably extends upwardly and rearwardly at a drive shaft angle α relative to horizontal. The drive shaft angle α is preferably in the range from 1 to 5°, more preferably in the range from 2 to 3.5°, and most preferably about 2.5°. A drive shaft angle α within the preferred range allows low placement of the seating 17, while the drive shaft avoidance recess 1511a still allows an acceptable volume to the power battery 15 and heat dissipation space 1211 with adequate battery clearance height H1.

The power battery 15 includes a battery housing 151 with two battery modules 152 disposed in the battery housing 151, achieving modularization of power battery 15. The battery modules 152 are distributed on left and right sides of the drive shaft avoidance recess 1511a, which can better balance the weight of the power battery 15. The battery housing 151 can further protect the battery modules 152 beyond the protection provided by the skidplate 121, avoiding potential safety hazards caused by damage to the battery modules 152, thereby improving the safety of the off-road vehicle 100.

The battery housing 151 preferably includes a detachable upper cover 1511 and a bottom shell 1512. The detachable connection facilitates the disassembly and assembly of the battery housing 151 to access the battery modules 152 for maintenance, replacement and repair.

The power battery 15 includes a battery management module 153 positioned within the battery housing 151 and electrically connected to the battery modules 152. The battery management module 153 controls the charging and discharging of the battery modules 152. By positioning the battery management module within the battery housing 151, wiring cost between the battery management module 153 and the battery modules 152 is reduced, and the battery housing 151 also provides protection for the battery management module 153.

The battery management module 153 is preferably positioned in front of the battery modules 152. Several plug-ins 154 are electrically connected to the battery management module 153, and are also positioned on the front side of the battery housing 151, reducing wiring harness length between the battery management module 153 and the plug-ins 154.

The off-road vehicle 100 includes an electrical system 22 and a fuel system 23, both at least partially mounted on the frame 11. As shown in FIG. 7, the electrical system 22 includes a charging port 221, a CDU (Conversion&Distribution Unit) module 223, and a CDU wiring harness 222. The charging port 221 is used to supply power to the power battery 15, and the CDU wiring harness 222 is used to connect the power battery 15, the charging port 221 and the CDU module 223. The fuel system 23 includes a fuel tank 231, a refueling port 232, and a fuel fill pipe 233. The fuel tank 231 is connected to the range extender 142, and the refueling port 232 is connected to the fuel tank 231 through the fuel fill pipe 233. The fuel port 232 and the charging port 221 are positioned on opposing right and left sides of the off-road vehicle 100, thereby maximizing separation between the fuel port 232 and the charging port 221 to improve safety of the off-road vehicle 100. A minimum harness-fuel fill distance D1 between the CDU wiring harness 222 and the fuel fill pipe 233 is preferably in the range from 260 mm to 500 mm, more preferably in the range from 320 mm to 440 mm, and most preferably 380 mm. Having a minimum harness-fuel fill distance D1 within the preferred ranges allows for a short CDU wiring harness 222 while still keeping the CDU wiring harness 222 far enough away from fuel in the fuel fill pipe 233 to minimize risk of igniting, thereby improving the safety of the off-road vehicle 100.

The charging port 221 extends along a charging port centerline 2211. A charging port centerline slope angle β between the charging port centerline 2211 and horizontal is preferably in the range from 20 to 40°, more preferably in the range from 25 to 35°, and most preferably about 30°. Having a charging port centerline slope angle β within the preferred ranges is conducive to insertion of a charging gun (not shown) into the charging port 221, while keeping the charging gun from falling off during the charging process.

The refueling port 232 extends along a refueling port centerline 2321. Like the charging port centerline slope angle β, a refueling port centerline angle γ between the refueling port centerline 2321 and horiztontal is preferably in the range from 20 to 40°, more preferably in the range from 25 to 35°, and most preferably about 30°. Having a refueling port centerline slope angle γ within the preferred ranges is conducive to insertion of a fuel gun (not shown) into the refueling port 232, while keeping the refueling gun from falling off during the refueling process.

The charging port 221 is preferably positioned on the left or right side of the off-road vehicle 100 near the drive motor 141, and the refueling port 232 is positioned on the opposing left or right side of the off-road vehicle 100 near the range extender 142. This positioning can reduce the cost of the CDU wiring harness 222 and the wiring harness cost between the charging port 221 and the power battery 15, and can also reduce the length of the fuel fill pipe 233 to the fuel tank 231 and the distance from the fuel tank 231 to the range extender 142, thereby improving the space utilization and structural compactness of the electrical system 22 and the fuel system 23.

The CDU module 223 is connected to the charging port 221 and to the power battery 15. AC power output from a charging gun is converted into DC power through the CDU module 223 for charging of the power battery 15. The CDU module 223 includes at least a transformer (not separately shown) and a charger (not separately shown). In addition, the CDU module 223 can also convert the high-voltage direct current output from the power battery 15 into low-voltage direct current, thereby supplying power to other electrical components of the electrical system 22 of the off-road vehicle 100. The CDU module 223 is preferably at least partially positioned on the upper side of the drive motor 141 adjacent to the charging port 221, which is conducive to reducing the length of the CDU wiring harness 222.

The fuel tank 231 is preferably positioned behind the seating 17, aligned widthwise with the range extender 142. The power battery 15 is preferably positioned in front of the drive motor 141, and the fuel tank 231 is preferably at least partially positioned between the drive motor 141 and the power battery 15. Through this positioning, the distance between the fuel tank 231 and the range extender 142 can be minimized to improve the structural compactness of the fuel system 23, and the space between the drive motor 141 and the power battery 15 can be fully utilized to improve the space utilization rate of the off-road vehicle 100.

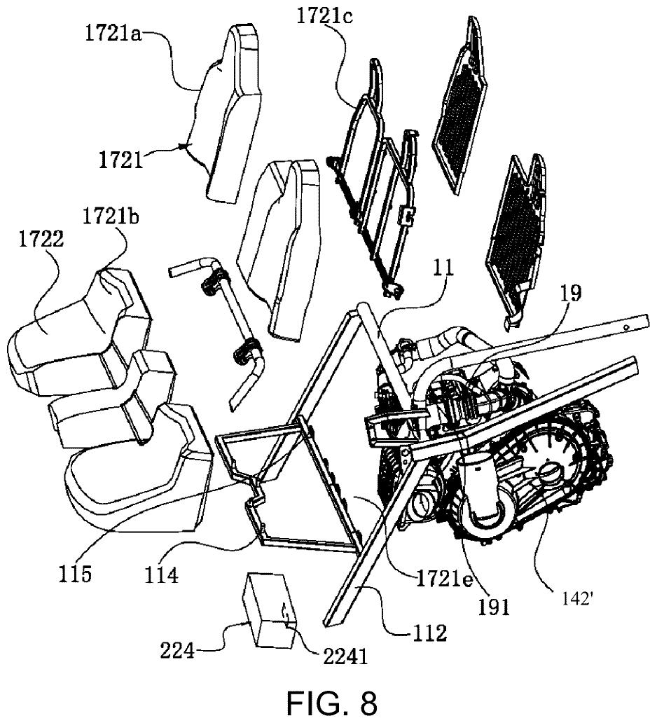

An inspection port 1721e is defined on the seating 17 near the fuel tank 231 as shown in FIG. 8. The fuel system 23 can be easily accessed through the maintenance port 1721e in the event of a malfunction.

The electrical system 22 further includes a generator controller 224 electrically connected between the range extender 142 and the power battery 15 as shown in FIGS. 8-10. The generator controller 224 is used to start the range extender 142 and recharge the power battery 15. The generator controller 224 is preferably at least partially positioned in front of the range extender 142, between the range extender 142 and the power battery 15 such as at least partially above the power battery 15. In front view, the generator controller 224 overlaps at least partially with the range extender 142.

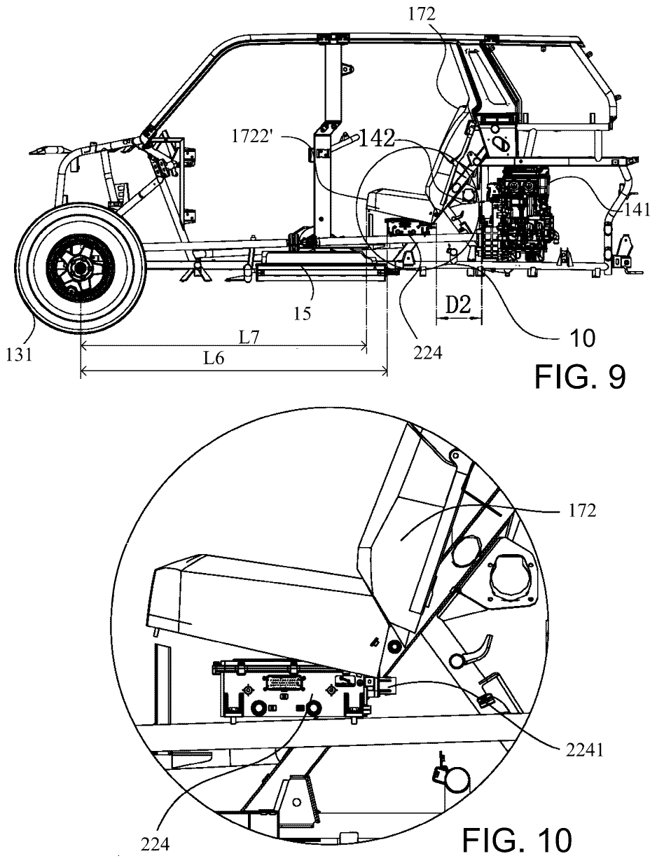

As shown in FIG. 9, the longitudinal distance between the axis of the front wheels 131 and the front-most end of the generator controller 224 is defined as a front axis-generator controller gap L6. The longitudinal distance between the axis of the front wheels 131 and the front-most end of the rear-row seating is defined as a front axis-rear-row seating gap L7. A generator controller-rear-row gap ratio L6/L7 of the front axis-generator controller gap L6 to the front axis-rear-row seating gap L7 is preferably in the range from 0.88 to 1.32, more preferably in the range from 0.99 to 1.21, and most preferably about 1.1. A generator controller-rear-row gap ratio L6/L7 in the preferred range helps keep the generator controller 224 away from the heat source of the range extender 142, thereby reducing the possibility of thermal failure of the generator controller 224, and making the generator controller 224 more convenient to repair.

A minimum generator controller - range extender longitudinal spacing distance D2 between the rear-most end of the generator controller 224 and the front end of the range extender 142 is preferably in the range from 192.8 mm to 289.2 mm, more preferably in the range from 216.9 mm to 265.1 mm, and most preferably about 241 mm. A value for minimum generator controller - range extender longitudinal spacing distance D2 within the preferred range keeps the generator controller 224 sufficiently far away from the heat source of the range extender 224 while avoiding interference between the generator controller 224 and the power battery 15.

In plan view, the rear-row seating 172 preferably at least partially overlaps with the generator controller 224, such as locating the generator controller 224 at least partially below the rear-row seat bottom cushion 1722. The rear-row seat bottom cushion 1722 is preferably detachably mounted on the frame 11, allowing ease of access and maintenance of the generator controller 224. The alternator/generator (not separately called out) of the range extender 142 is preferably disposed on the side of the range extender 142 facing the generator controller 224.

As shown in FIG. 8 and FIG. 10, the generator controller 224 further includes an interface component 2241, which is used to electrically connect the generator controller 224 to the range extender 142, the power battery 15, and the drive motor 141. FIG. 8 also shows an alternative range extender 142′ having a continuously variable transmission (CVT). For more orderly wiring, the interface component 2241 is arranged on the back of the generator controller 224, toward the range extender 142, 142′.

The electrical system 22 further includes a motor controller 225 for controlling the operation of the drive motor 141. The motor controller 225 is preferably arranged above the drive motor 141 for ease of inspection and maintenance and to improve the overall balance of the off-road vehicle 100.

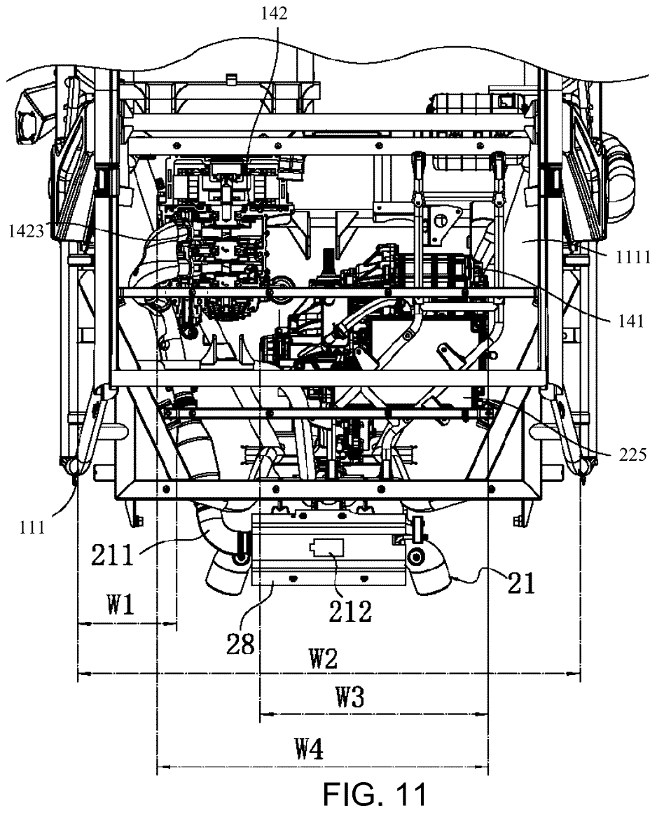

In plan view, the maximum lateral interval between the exhaust pipe 211 and the rear frame 111 is defined as an exhaust pipe inward spacing W1 as shown in FIG. 11. The width of the rear frame 111 is defined as a rear frame width W2. An exhaust pipe inward spacing ratio W1/W2 of the exhaust pipe inward spacing W1 to the rear frame width W2 is preferably in the range from 0.1 to 0.3, more preferably in the range from 0.12 to 0.27, and most preferably in the range from 0.14 to 0.24. A value for exhaust pipe inward spacing ratio W1/W2 within the preferred range keeps the exhaust pipe 211 from being too widely exposed on the outside of the vehicle 100, while preventing the heat of the exhaust pipe 211 from being too close to the components such as the drive motor 141 and the motor controller 225.

The exhaust system 21 further includes a muffler 212, and the off-road vehicle 100 further includes a thermal insulation assembly 28 at least partially disposed between the muffler 212 and the motor controller 225. More specifically, the thermal insulation assembly 28 is at least partially surrounded by the drive motor 141, the motor controller 225, and/or the CDU module 223. The thermal insulation assembly 28 is at least partially arranged around the outer circumference of the muffler 212, and is fixedly connected to the muffler 212, preferably before the muffler 212 is secured to the rear frame 111. The thermal insulation assembly 28 helps to optimize the working environment of the drive motor 141, the motor controller 225, and/or the CDU module 223 and improve their performance, avoiding thermal failure caused by the high temperature of the muffler 212. The minimum separation distance between the drive motor 141 and the muffler 212 is greater than or equal to 100 mm, further helping to thermally protect the drive motor 141.

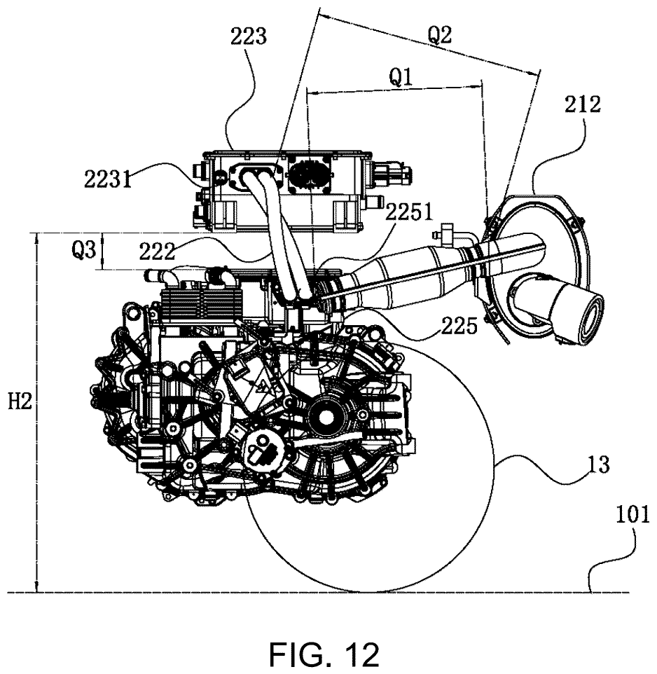

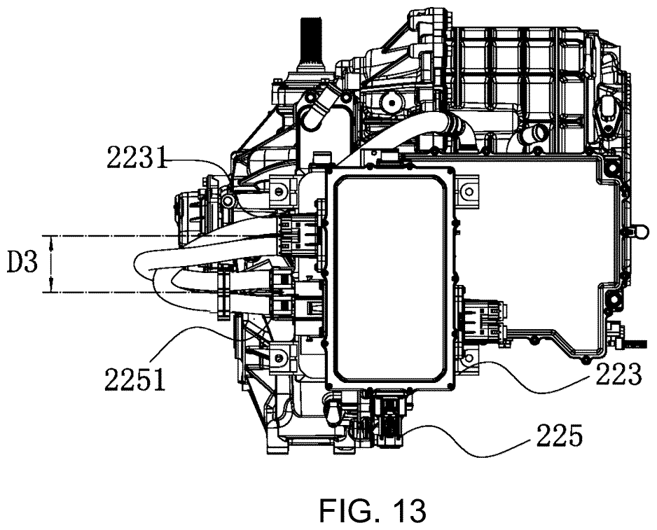

As shown in FIG. 12 and FIG. 13, as an embodiment, the motor controller 225 includes several motor controller interfaces 2251 connected to the CDU wiring harness 222, positioned on the left and/or right side of the motor controller 225. The minimum motor controller interface-to-muffler distance Q1 between the motor controller interfaces 2251 and the muffler 212 is greater than or equal to 100 mm, thereby keeping the CDU wiring harness 222 away from the heat of the muffler 212.

The CDU module 223 is positioned above the motor controller 225 and connected to the motor controller 225 through the CDU wiring harness 222. The CDU module 223 includes several CDU module interfaces 2231, all of which are arranged to face the same left and/or right side of the off-road vehicle 100 similar to the motor controller interfaces 2251. The minimum CDU module interface-to-muffler distance Q2 between the CDU module interfaces 2231 and the muffler 212 is preferably greater than or equal to 100 mm, and more preferably greater than or equal to 200 mm, in order to keep the CDU wiring harness 222 away from heat of the muffler 212 and improve the service life of the CDU wiring harness 222. The CDU wiring harness 222 is flexible, and the preferred motor controller interface-to-muffler distance Q1 and CDU module interface-to-muffler distance Q2 help prevent heat degradation of the CDU wiring harness 222 even should it bend or deflect toward the muffler 212.

A longitudinal interface spacing distance D3 between the first interface 2251 and the second interface 2231 along the length direction of the off-road vehicle 100 is preferably in the range from 64 mm to 96 mm, more preferably in the range from 72 mm to 88 mm, and most preferably about 80 mm. A value for longitudinal interface spacing distance D3 within the preferred range helps shorten the length of the CDU wiring harness 222. In plan view, the CDU module 223 overlaps at least partially with the motor controller 225, further shortening the length of the CDU wiring harness 222 between the CDU module 223 and the motor controller 225.

A CDU module elevation H2 between the lowest end of the CDU module 223 and the ground plane 101 is preferably in the range from 770 mm to 940 mm, more preferably in the range from 810 mm to 900 mm, and most preferably about 855 mm. Both sides of the CDU module 223 are fixedly connected to the rear frame 111. A CDU module—motor controller installation gap Q3 is defined between the CDU module 223 and the motor controller 225. The CDU module—motor controller installation gap Q3 is preferably in the range from 48 mm to 72 mm, more preferably in the range of 54 mm to 66 mm, and most preferably 60 mm. Values for CDU module elevation H2 and CDU module—motor controller installation gap Q3 within the preferred ranges help improve the water wading performance of the CDU module 223 while still avoiding interference between the CDU module 223 and the cargo container 18.

The gear reduction unit 161 is arranged on the inner side of the drive motor 141 near the range extender 142, connected to the front drive shaft 162 for torque transmission. Positioning the gear reduction unit 161 at or near the longitudinal midplane 102 helps improve the compactness of the drive train 16.

The drive motor 141, the motor controller 225, and the gear reduction unit 16 are preferably preassembled as a drive combination unit prior to attachment to the rear frame 111. The width of the drive combination unit is defined as a drive combination width W3. A drive combination width ratio W3/W2 of the drive combination width W3 to the rear frame width W2 is preferably in the range from 0.36 to 0.54, more preferably in the range from 0.4 to 0.5, and most preferably about 0.47.

The center of gravity of the drive combination unit and the center of gravity of the range extender 142 are respectively positioned on opposing right and left sides of the front drive shaft 162, improving the overall balance of the off-road vehicle 100. The range extender 142 is at least partially positioned in front of the drive combination unit. In front view, the range extender 142 overlaps at least partially with the drive combination unit, specifically overlapping at least partially with the gear reduction unit 16.

The fuel tank 231 is preferably positioned on the right side of the range extender 142, in front of the drive combination unit. This preferred positioning of the fuel tank 231 helps improve the overall balance of the off-road vehicle 100.

The plan view area of the drive combination unit preferably occupies from 16 to 25% of the plan view area of the rear receiving space 1111, and more preferably occupies from 18 to 22% of the plan view area of the rear receiving space 1111, and most preferably occupies about 20% of the plan view area of the rear receiving space 1111. The combined width of the range extender 142 and the drive combination unit is defined as a locomotive power system width W4. A locomotive power system width ratio W4/W2 of the locomotive power system width W4 to the rear frame width W2 is preferably in the range from 0.53 to 0.8, more preferably in the range from 0.6 to 0.73, and most preferably in the range from 0.63 to 0.69.

In addition to the rear-row seat bottom cushion 1722, the rear-row seating 172 includes a backrest 1721 that is at least partially connected to the rear-row seat bottom cushion 1722. The backrest 1721 preferably includes a pivotable upper backrest 1721a and a stationary lower backrest 1721b as shown in FIG. 8. Specifically, the lower backrest 1721b is preferably integrally formed with the rear-row seat bottom cushion 1722, and the rear-row seat bottom cushion 1722 is detachably connected to the frame 11. The upper backrest 1721a is pivotally connected to the frame 11 through an upper bracket 1721c.

As another embodiment shown in FIGS. 8, 10 and 14, a lower backrest 1721b′ is independent of the rear-row seat bottom cushion 1722′, and the lower backrest 1721b′ is detachably connected on a lower bracket 1721d which is fixedly connected to the frame 11. The upper backrest 1721a is pivotally connected to the lower bracket 1721d, that is, the upper backrest 1721a is not pivotally connected to the frame 11. Optionally, the upper backrest 1721a is rotatably connected to the lower bracket 1721d through an upper bracket 1721c provided on the upper backrest 1721a. Through the above, it is possible to facilitate the disassembly or assembly of the lower backrest 1721b′ and rear-row seat bottom cushion 1722′. After disassembling the lower backrest 1721b′ from the rear-row seat bottom cushion 1722′, parts of the off-road vehicle 100 positioned behind the lower backrest 1721b can be inspected, removed and/or replaced, thereby reducing the maintenance cost of the off-road vehicle 100.

The frame 11 is equipped with a first engaging member 114 and a first snap-fit member 115 as shown in FIG. 8, and the bottom of the rear-row seat bottom cushion 1722 is provided with a second engaging member (not shown in the figure) and a second snap-fit member (not shown in the figure). The first engaging member 114 and the second engaging member are inserted, and the first snap-fit member 115 and the second snap-fit member are clamped to achieve a detachable connection between the frame 11 and the rear-row seat bottom cushion 1722, thereby improving the efficiency of disassembling and assembling the rear-row seat bottom cushion 1722, and facilitating the maintenance of components such as the generator controller 224 on the lower side of the rear-row seat bottom cushion 1722.

The rear end of the rear-row seat bottom cushion 1722 is preferably embedded in the first snap-fit member 115. The first snap-fit member 115 surrounds to form a slot for the rear-row seat bottom cushion 1722 to be inserted, and the first snap-fit member 115 extends at least partially along the width direction of the off-road vehicle 100. When the rear-row seat bottom cushion 1722 is inserted into the slot, it can rotate around the first snap-fit member 115. As an embodiment, the first engaging member 114 may be a pin that extends along the height direction, and the bottom surface of the rear-row seat bottom cushion 1722 has a hole that can cooperate with the first engaging member 114. When the rear-row seat bottom cushion 1722 is connected to the middle frame 112, the pin is at least partially received in the hole. Through the above, the convenience of disassembling rear-row seat bottom cushion 1722 is improved, thereby reducing the difficulty of repairing and replacing generator controller 224.

A projection of the lower backrest 1721b along the length direction of the off-road vehicle 100 on the transverse plane 103 is defined as a lower backrest projection, and the projection of the backrest 1721 along the length direction of the off-road vehicle 100 on the transverse plane 103 is defined as a backrest projection. A ratio of the area of the lower backrest projection to the area of the backrest projection is in the range from 0.29 to 0.56. More preferably, the ratio of the area of the lower backrest projection to the area of the backrest projection is in the range from 0.36 to 0.49. Most preferably, the ratio of the area of the lower backrest projection to the area of the backrest projection may be 0.43. Through the above, it is possible to avoid the operating space of the inspection port 1721e formed after disassembling the lower backrest 1721b being too small, thereby facilitating the inspection of the parts of the off-road vehicle 100 positioned behind the lower backrest 1721b and under the rear-row seat bottom cushion 1722, and reducing the maintenance cost of the off-road vehicle 100. It can also avoid the operation space of the inspection port 1721e defined by disassembling the backrest 1721b from being too large and occupying additional layout space, thereby improving the space utilization of the off-road vehicle 100 and enhancing the structural compactness of the rear-row seating 172.

The range extender 142 is positioned behind the lower backrest 1721b, 1721b′. In front view, the lower backrest 1721b, 1721b′ overlaps at least partially with the range extender 142. The front view overlapping area of the lower backrest 1721b, 1721b′ and the range extender 142 is preferably in the range from 627 cm² to 941 cm², more preferably in the range from 705 cm² to 863 cm², and most preferably 784 cm². Too small of a front view overlapping area of the lower backrest 1721b, 1721b′ and the range extender 142 results is poor access to the range extender 142 through the access hole 1721e, which is not conducive to the inspection and maintenance of the range extender 142.

The air intake system 19 includes an air filter 191 arranged on the locomotive power system 14 as called out in FIG. 8. The air filter 191 is arranged on the rear side of the rear-row seating 172 for delivering air to the locomotive power system 14. Optionally, the air filter 191 is at least partially positioned in front of the range extender 142, and is further positioned near the lower backrest 1721b. The air filter 191 is connected to the range extender 142. In front view, the air filter 191 overlaps at least partially with the lower backrest 1721b. The inspection port 1721e overlaps at least partially with the air filter 191. Due to the need to filter the air entering the range extender 142, the air filter 191 is prone to dust accumulation and blockage, which can affect its normal operation. Therefore, it is necessary to inspect and maintain the air filter 191. Because the air filter 191 positioned behind the lower backrest 1721b can be inspected and/or replaced through the inspection port 1721e, maintenance cost is reduced.

In order to achieve the loading and unloading between the lower backrest 1721b and the lower bracket 1721d, and facilitate the inspection and maintenance of the range extender 142 and the air filter 191, a clamp is provided on the lower backrest 1721b, which is arranged on the rear end face of the lower backrest 1721b and used to connect the lower bracket 1721d. The connection between the clamp and the lower bracket 1721d can be achieved through fitting and rotation to facilitate quick disassembly or installation between the lower backrest 1721b and the lower bracket 1721d. Through the above, the inspection and maintenance of the range extender 142 and the air filter 191 are facilitated, thereby improving the maintenance convenience of the off-road vehicle 100.

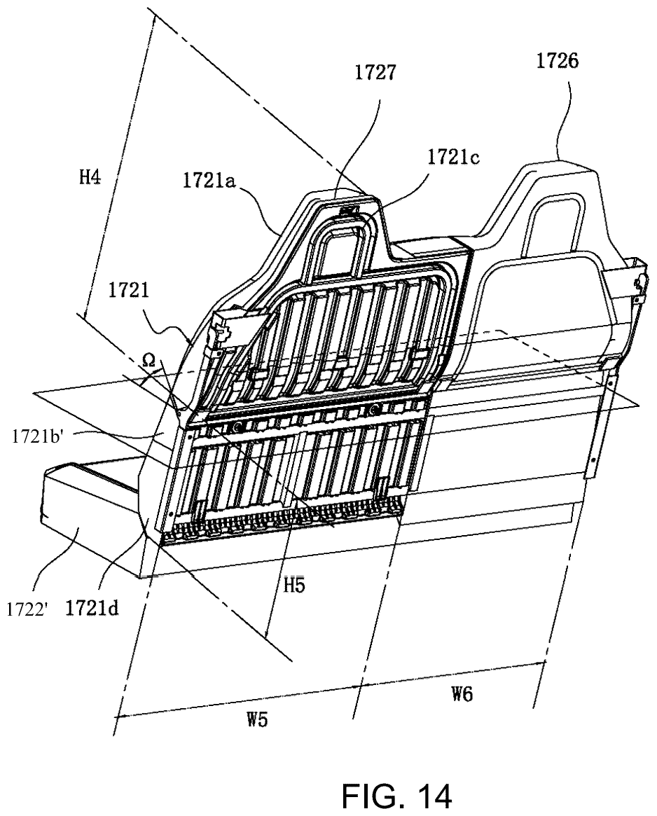

The upper backrest 1721a has an upper backrest height H4, and the lower backrest 1721b′ has a lower backrest height H5, both called out in FIG. 14. A backrest height ratio H4/H5 of the upper backrest height H4 to the lower backrest height H5 is preferably in the range from 1.8 to 2.6, more preferably in the range from 2 to 2.4, and most preferably about 2.2.

The generator controller 224 is positioned below the rear-row seat bottom cushion 1722 and between the power battery 15 and the range extender 142. In plan view, the rear-row seat bottom cushion 1722 overlaps at least partially with the generator controller 224. As such, it is possible to inspect and repair the generator controller 224 when the rear-row seat bottom cushion 1722 is removed, which improves the maintenance convenience of the off-road vehicle 100.

In the embodiment shown in FIG. 14, the lower backrest 1721b′ is in surface contact with the upper backrest 1721a, defining a contact surface that extends towards the upper front of the off-road vehicle 100. A backrest contact surface angle Ω defined between the contact surface and horizontal is preferably in the range from 0 to 90°, more preferably in the range from 10 to 80°, and most preferably in the range from 20 to 70°. A proper value for backrest contact surface angle Ω avoids interference between the lower backrest 1721b′ and the upper backrest 1721a during the loading and unloading process of the lower backrest 1721b′, thereby improving the assembly of the lower backrest 1721b′.

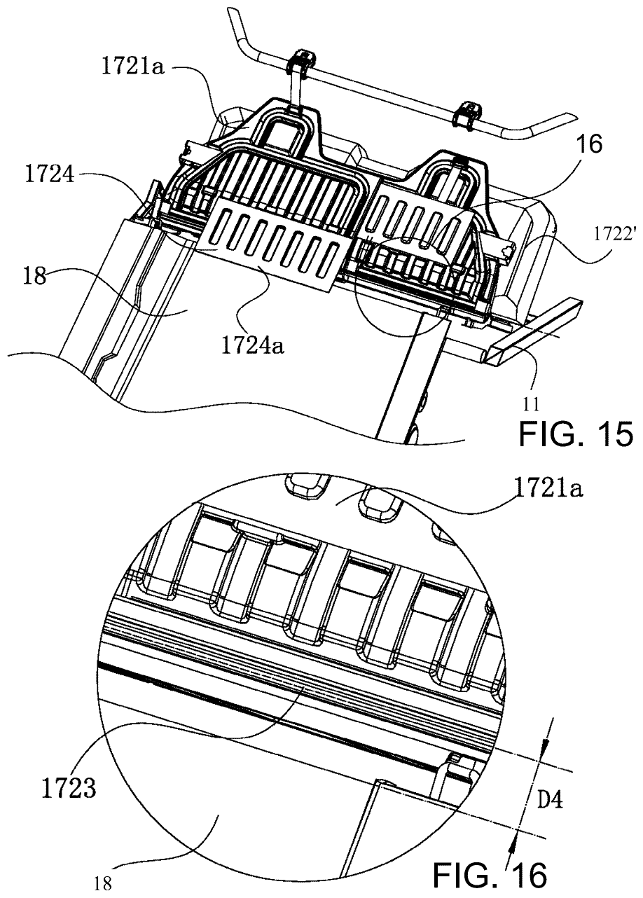

FIGS. 15-17 show pivoting/folding of the upper backrest 1721a. The upper backrest 1721a has an upright position for seating and a folded position for carrying cargo. When the upper backrest 1721a is in the upright position, the extension direction of the rear side of the upper backrest 1721a and the rear side of the lower backrest 1721b are substantially the same, so that the upper backrest 1721a and the lower backrest 1721b cooperate to support the passenger's back, thereby improving the comfort of the rear-row seating 172. When the upper backrest 1721a is in the folded position, the height of the rear side of the upper backrest 1721a and the cargo surface of the cargo container 18 are substantially the same, and the rear side of the upper backrest 1721a is substantially parallel to the cargo surface of the cargo container 18, so that the upper backrest 1721a can cooperate with the cargo surface of the cargo container 18 in the folded position to lengthen the cargo length of the cargo container 18, thereby increasing the cargo space of the off-road vehicle 100. Because the upper backrest 1721a can be moved between two usage modes to integrate cargo and support functions, the functional diversity of the upper backrest 1721a enhances the practicality of the off-road vehicle 100.

The upper bracket 1721c is pivotally connected to the lower bracket 1721d using a hinge pin 1723. The minimum hinge pin spacing distance D4 between the axis of the hinge pin 1723 and the cargo surface of the cargo container 18 is preferably in the range from 66 mm to 125 mm, more preferably in the range from 81 mm to 110 mm, and most preferably 95.2 mm. Interference between the upper backrest 1721 a during rotation around the hinge pin 1723 and the cargo container 18 is avoided.

The rear-row seating 172 further includes a connection plate 1724 rotatably connected to the upper bracket 1721c or the upper backrest 1721a. The connection plate 1724 extends along the preset plane 1724a. The connection plate 1724 includes a stowed state and a working state. When the connection plate 1724 is in the stowed state, the extension direction of the preset plane 1724a and the rear side of the lower backrest 1721b is substantially the same. When the connection plate 1724 is in the working state, the preset plane 1724a is substantially parallel to the cargo surface of the cargo container 18. At this time, one end of the connection plate 1724 rotates to connect to the upper bracket 1721c or the upper backrest 1721a, and the other end of the connection plate 1724 overlaps with the cargo surface of the cargo container 18, so that the connection plate 1724 can compensate for the gap between the hinge pin 1723 and the cargo surface of the cargo container 18 in the working state, prevent the cargo from falling out of the gap between the hinge pin 1723 and the cargo surface of the cargo container 18, and thus improve the cargo safety of the off-road vehicle 100.

As an embodiment, the rotation direction of the upper bracket 1721c relative to the lower skeleton 1721d is the first rotation direction, that is, the rotation direction of the upper backrest 1721a switching from the upright position to the folded position is the first rotation direction. The rotation direction of the connection plate 1724 relative to the upper bracket 1721c or the upper backrest 1721a is the second rotation direction, that is, the rotation direction of the connection plate 1724 from the stowed state to the working state is the second rotation direction. The first rotation direction is opposite to the second rotation direction.

As an embodiment, when the upper bracket 1721c and the frame 11 are rotated and connected, that is, when the rear-row seat bottom cushion 1722 and the lower backrest 1721b are connected, the cargo container 18 extends to the rear-row seating 172 and forms a cargo extension surface 181. When the upper backrest 1721a is in the folded position, the cargo extension surface 181 and the rear side of the upper backrest 1721a are in contact, which can eliminate the structure of the connection plate 1724, simplify the structure of the rear-row seating 172, improve the compactness of the rear-row seating 172, and reduce the production cost of the rear-row seating 172.

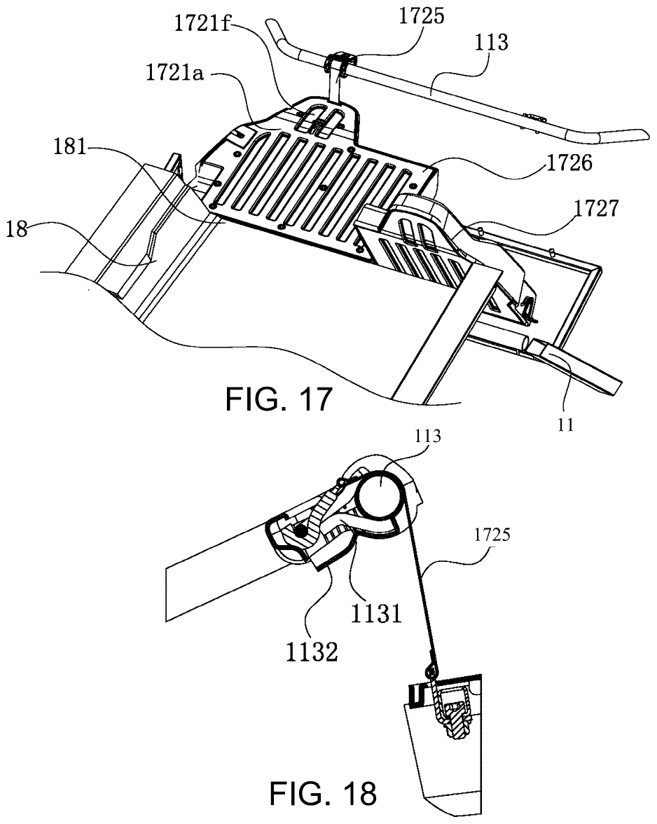

As shown in FIG. 17 and FIG. 18, as an embodiment, the rear-row seating 172 also includes a connection structure 1725 arranged on the upper backrest 1721a. The upper backrest 1721a includes a preset position that cooperates with the cargo container 18 to carry goods. When the upper backrest 1721a is in the preset position, that is, when the upper backrest 1721a is in the folded position, the upper backrest 1721a is fixed to the frame 11 through the connection structure 1725. Optionally, when the upper backrest 1721a rotates to the preset position, it can be connected to the frame 11 through the connection structure 1725, so that the upper backrest 1721a is always in the preset position, to avoid the upper backrest 1721a being overloaded and causing it to continue to rotate, thereby preventing the goods on the upper backrest 1721a from detaching from the cargo container 18, and further improving the working stability of the upper backrest 1721a. Through the above, it is possible to expand the cargo space of the cargo container 18, improve the cargo capacity of off-road vehicle 100, and enhance the stability of the fit between upper backrest 1721a and the cargo container 18. As an optional embodiment, the connection structure 1725 may be arranged as a detachable structure such as webbing, hooks, locks, etc.

As an embodiment, a storage groove 1721f is defined on the rear side of the upper backrest 1721a to accommodate the connection structure 1725. When the connection structure 1725 is in a non-working state, at least a portion of the connection structure 1725 is received in the storage groove 1721f, which can avoid interference between the connection structure 1725 and other components of the seating 17, and improve the protective effect on the connection structure 1725, thereby increasing the service life of the connection structure 1725. In addition, through the above, the space utilization and structural compactness of the rear backrest 1721 can also be improved.

As an embodiment, in the case where a connection plate 1724 is provided on the upper bracket 1721c or upper backrest 1721a, when the connection plate 1724 is in a stowed state and the connection structure 1725 is in a non-working state, the connection plate 1724 at least partially covers the connection structure 1725 to maintain its fixation.

In this embodiment, the frame 11 includes an armrest frame 113 positioned in front of the rear-row seating 172. When the upper backrest 1721a is in a predetermined position, the upper backrest is fixed to the armrest frame 113 through a connection structure 1725. Optionally, when the upper backrest 1721a is in the preset position, one end of the connection structure 1725 is connected to the upper backrest 1721a, and the other end of the connection structure 1725 is provided with a connection member 1725a. The armrest frame 113 is provided with a fixing member 1131 that cooperates with the connection member 1725a to prevent the connection structure 1725 from sliding on the armrest frame 113, thereby improving the stability of the connection between the connection structure 1725 and the armrest frame 113.

As an embodiment, the armrest frame 113 is further provided with an anti detachment structure 1132. When the fixed portion 1131 and the connection member 1725a are fixed together, the anti detachment structure 1132 at least partially surrounds the connection portion 1725a, thereby preventing the connection member 1725a from falling off from the fixing member 1131 and improving the connection strength between the connection structure 1725 and the armrest frame 113.

As an embodiment, the rear-row seats 172 include a single rear-row seating 1726 and a multiple person rear-row seating 1727, which are distributed along the width direction of the off-road vehicle 100. The single seat 1726 can accommodate a single person, and the multi seat 1727 can accommodate at least two people. Optionally, both the single seat 1726 and the multi seats 1727 include the aforementioned backrest 1721 and rear-row seat bottom cushion 1722 to meet different cargo and passenger needs, thereby enhancing the functional diversity of the rear-row seats 172. More optionally, the width of the multi seat 1727 extending along the width direction of the off-road vehicle 100 is defined as a multi-seat width W5, and the width of the single seat 1726 extending along the width direction of the off-road vehicle 100 is defined as a single seat width W6, where the multi-seat width W5 is greater than the single seat width W6. The air filter 191 is positioned behind the multi person seats 1727, and the multi person seat 1727 at least partially overlaps with the air filter 191 in front view. Through the above, it is possible to inspect and repair the air filter 191 through the multi seat 1727. In addition, due to the multi-seat width W5 being greater than the single seat width W6, more maintenance space is provided for inspection, repair and/or maintenance of the air filter 191.

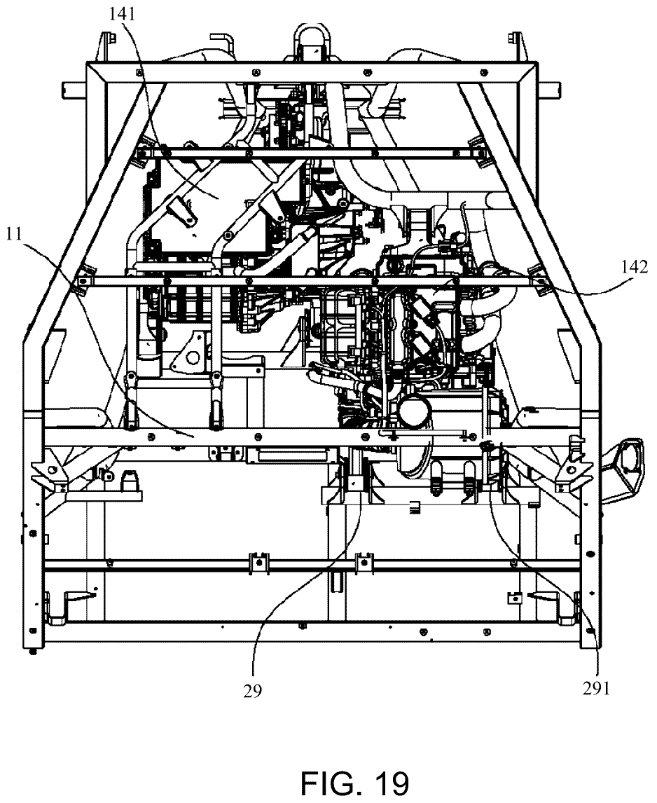

As shown in FIG. 19, the off-road vehicle 100 further includes one or more sets of hangers 29. The set of hangers 29 can be arranged between the range extender 142 and the frame 11, and the set of hangers 29 can also be arranged between the drive motor 141 and the frame 11. The set of hangers 29 preferably have a shock-absorbing effect on the locomotive power system 14 so as reduce the transmission of vibration between the locomotive power system 14 and the frame 11, while also having a supporting and a limiting effect on the locomotive power system 14.

An axis of the set of hangers 291 preferably extends laterally. When the locomotive power system 14 is a combination of the range extender 142 and the drive motor 141, the minimum distance between the drive motor 141 and the range extender 142 is greater than 0. The drive motor 141 and the range extender 142 are arranged independently of each other. After being arranged independently, the drive motor 141 and the range extender 142 can be easily maintained and serviced separately. At the same time, different drive motors 141 and range extenders 142 can be selected for use in combination according to actual needs. The front end of the drive motor 141 is connected to frame 11 through at least one (preferably two) hangers 291, the rear end of the drive motor 141 is connected to frame 11 through at least one (preferably one) hanger 291, the front end of range extender 142 is connected to frame 11 through at least one (preferably two) hangers 291, and the rear end of range extender 142 is connected to frame 11 through at least one (preferably one) hanger 291. Using three hangers 291 forms a stable triangular attachment structure, enhancing the connection stability between the drive motor 141 and/or range extender 142 and the frame 11.

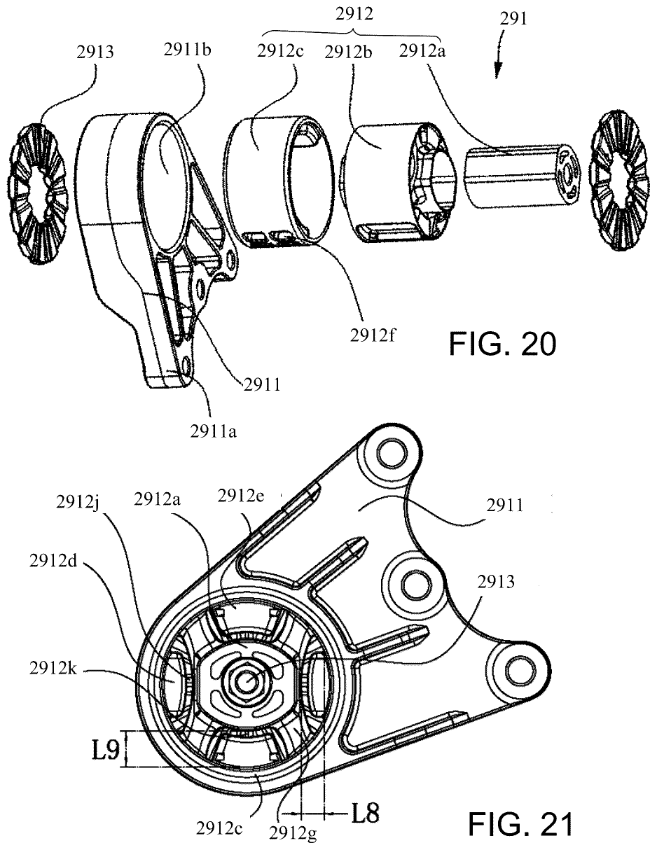

As shown in FIG. 20, each hanger 291 includes a base 2911 and a hanging bushing 2912. One end of the base 2911 is provided with a connection portion 2911a connected to the drive motor 141 or the range extender 142, and the other end of the base 2911 is provided with an installation hole 2911b. The hanging bushing 2912 is received in the installation hole 2911b, and is further connected to the frame 11 through a fastener 2913 extending transversely. The hanging bushing 2912 and the mounting hole 2911b are coaxially arranged. Each hanger 291 may be fixedly connected to the drive motor 141 or the range extender 142 through the connection portion 2911a and fixing devices such as bolts on the base 2911. Each hanger 291 can be fixedly connected to the frame 11 through the mounting hole 2911b, the hanging bushing 2912, and fixing devices such as bolts on the base 2911, that is, the drive motor 141 or the range extender 142 may be fixedly connected to the frame 11 through the base 2911 and hanging bushing 2912. Through the above, the connection stability between frame 11 and drive motor 141, as well as the frame 11 and the range extender 142, can be improved.

Each hanger 291 also includes collision pads 2913, which are provided on two sides of the hanging bushing 2912 or the mounting hole 2911b. The collision pads 2913 can buffer force between the hanger 291 and the frame 11 in the width direction of the off-road vehicle 100. The anti-collision pads 2913 may be made of materials such as rubber pads to improve the cushioning performance of the hanger 291, thereby increasing the service life of the hanger 291.

The hanging bushing 2912 preferably includes an inner core 2912a, a buffer 2912b, and an outer tube 2912c. The inner core 2912a, the buffer 2912b, and the outer tube 2912c are coaxially arranged, with the buffer 2912b sleeved on the outer side of the inner core 2912a and the outer tube 2912c sleeved on the outer side of the buffer 2912b. The inner core 2912a is fixedly connected to the buffer 2912b, and the buffer 2912b is fixedly connected to the outer tube 2912c. The buffer 2912b can be made of rubber block material, so that the hanging bushing 2912 can have both buffering and supporting functions. The inner core 2912a, the buffer 2912b, and outer tube 2912c can be assembled and subjected to vulcanization treatment to improve their durability and structural strength, thereby facilitating the improvement of the structural stability of the hanger 291.

As shown in FIG. 21, a first plane is defined as passing through the axis of the outer tube 2912c and perpendicular to the length direction of the off-road vehicle 100, and a second plane is defined as passing through the axis of the outer tube 2912c and perpendicular to the height direction of the off-road vehicle 100. At least two first soft limit portions 2912d and at least two second soft limit portions 2912e are provided on the inner side of the outer tube 2912c. The two first soft limit portions 2912d are symmetrically aligned about the first plane, and the two second soft limit portions 2912e are symmetrically aligned about the second plane. The first soft limit portion 2912d and the second soft limit portion 2912e are uniformly arranged around the inner core 2912a and the outer tube 2912c, and are positioned near the inner wall of the outer tube 2912c, so that the first soft limit portion 2912d and the second soft limit portion 2912e can first buffer the strong vibration generated by the range extender 142 or the drive motor 141, thereby improving the shock absorption effect of the set of hangers 291.

The second soft limit portion 2912e is preferably also equipped with at least two hard limit members 2912f (as shown in FIG. 20), which are symmetrical arranged about the second plane. When the off-road vehicle 100 is driving on harsh road conditions, road excitation causes significant vibration in the height direction of the locomotive power system 14. The hard limit member 2912f further supports the drive motor 141 and the range extender 142, thereby improving the stability of the drive motor 141 and the range extender 142, and thus enhancing the connection stability of the locomotive power system 14.

The buffer 2912 b preferably includes a hard limit portion 2912g, which is in contact with the inner wall of the outer tube 2912c and the outer wall of the inner core 2912a. The hard limit portion 2912g is used to support the outer tube 2912c and the inner core 2912a. In the case of significant vibration generated by the drive motor 141 or the range extender 142, the hard limit portion 2912g can improve the support performance of the buffer 2912b, so that the outer tube 2912c and the inner core 2912a will not undergo significant deformation, thereby improving the connection stability between the outer tube 2912c and the inner core 2912a.

The size of the inner core 2912a in the length direction of the off-road vehicle 100 is preferably greater than or equal to the size of the inner core 2912a in the height direction, and the size of the hard limit portion 2912g in the length direction of the off-road vehicle 100 is less than or equal to the size of the hard limit portion 2912g in the height direction. The smaller size of the inner core 2912a in the height direction enables the buffer 2912b positioned between the inner core 2912a and the outer tube 2912c to have a larger size in the height direction, further enhancing the support and shock absorption performance of the buffer 2912b in the height direction. Optionally, the hard limit portion 2912g in the buffer 2912b has a larger size in the height direction, which can increase the proportion of the hard limit portion 2912g in the height direction of the buffer 2912b, and endow the buffer 2912b with better support and shock absorption performance in the height direction.

The buffer 2912b preferably includes a first linear segment 2912j distributed along the length direction of the off-road vehicle 100 and a second linear segment 2912k distributed along the height direction. The first linear segment 2912j is the partial cavity structure distributed along the length direction of the off-road vehicle 100 in the buffer 2912b, and the second linear segment 2912k is the partial cavity structure distributed along the height direction in the buffer 2912b. Both the first linear segment 2912j and the second linear segment 2912k can reduce vibration transmission, increase the isolation rate of hanging assemblies, and improve the overall comfort of off-road vehicle. In the radial direction of the inner core 2912a, the size L8 of the first linear segment 2912j is in the range from 2 mm to 4 mm, and the size L9 of the second linear segment 2912k is in the range from 1.75 mm to 3.25 mm. The linear segment in buffer 2912b can provide better shock absorption effect, but its ability to provide support effect is poor. Setting the second linear segment 2912k to have a relatively smaller size can improve the distribution ratio of the hard limit portion 2912g in the height direction of the second linear segment 2912k, which can further enhance the support and shock absorption performance of buffer 2912b in the height direction.

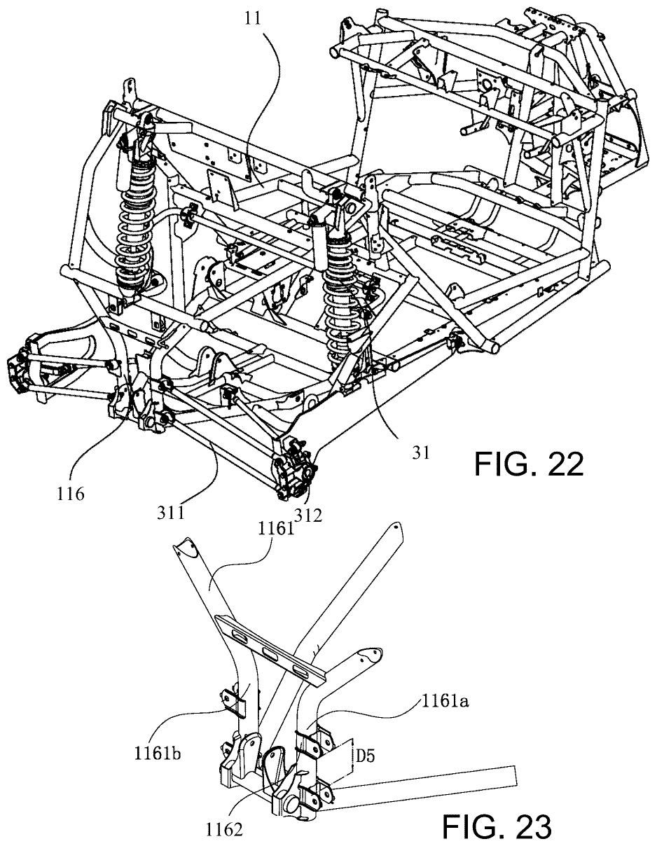

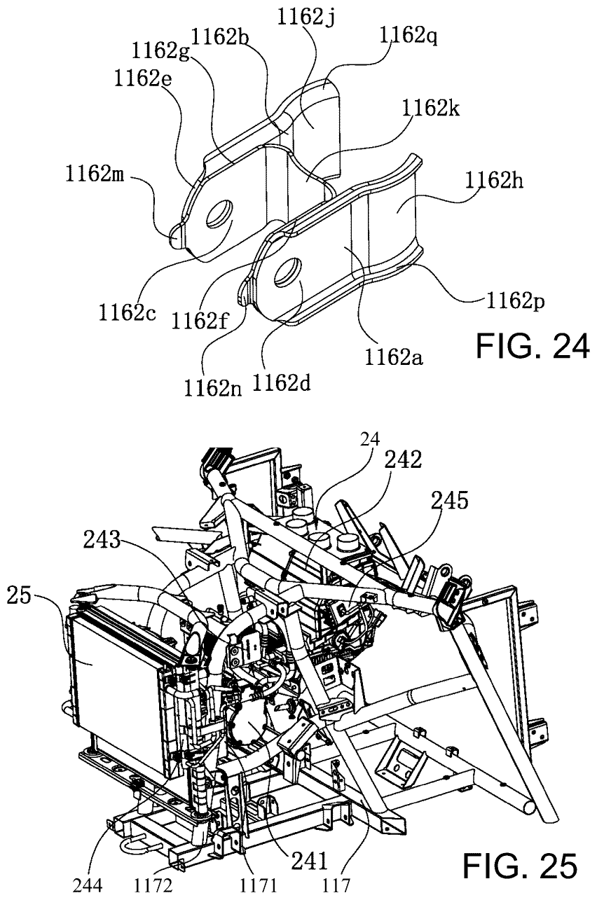

As shown in FIGS. 22-24, the off-road vehicle 100 further includes a rear suspension 31, and both of the rear wheels 132 are connected to the frame 11 through the rear suspension 31. The rear suspension 31 includes left and right sets of upper and lower control arms 311 and left and right rear knuckles 312. The frame 11 includes a rear control arm support section 116.

The rear control arm support section 116 includes supports 1161 including a right support post 1161a and a left support post 1161b, with two control arm connection seats 1162 for the respective upper and lower control arm 311 on each support post 1161a, 1161b. Each control arm connection seat 1162 is fixedly connected to its support post 1161a, 1161b. The inner end of each control arm 311 is pivotally connected to rear control arm support section 116 through a control arm connection seat 1162. The outer end of each control arm 311 is connected to the respective knuckle 312.

Each control arm connection seat 1162 includes a first side connection plate 1162a, a second side connection plate 1162b, and a middle connection plate 1162c. A portion of the middle connection plate 1162c is connected to the first side connection plate 1162a, and another part of the middle connection plate 1162c is connected to the second side connection plate 1162b. A portion of the first side connection plate 1162a is in contact with the respective support post 1161a or 1161b, a portion of the second side connection plate 1162b is in contact with the respective support post 1161a or 1161b, and a portion of the middle connection plate 1162c is in contact with the respective support post 1161a or 1161b. The first side connection plate 1162a, the second side connection plate 1162b, and the middle connection plate 1162c provide a stable connection between the rear control arm support section 116 and the control arm connection seat 1162. The connection method between the rear control arm support section 116 and the control arm connection seat 1162 can use welding or other connection methods to avoid deformation of the control arm connection seat 1162.

The first side connection plate 1162a includes a first connection portion 1162d, the second side connection plate 1162b includes a third connection portion 1162e, and the middle connection plate 1162c includes a fifth connection portion 1162f and a sixth connection portion 1162g. The fifth connection portion 1162f is connected to the first connection portion 1162d, and the sixth connection portion 1162g is connected to the third connection portion 1162e. The first connection portion 1162d and the fifth connection portion 1162f are fixedly connected by welding or other connection methods. The above settings are conducive to improving the connection stability of the first connection portion 1162d and the fifth connection portion 1162f, the third connection portion 1162e and the sixth connection portion 1162g, thereby improving the connection stability of the control arm connection seat 1162.

The first side connection plate 1162a also includes a second connection portion 1162h, the second side connection plate 1162b also includes a fourth connection portion 1162j, the middle connection plate 1162c also includes a seventh connection portion 1162k, and the fifth connection portion 1162f, the seventh connection portion 1162k, and the sixth connection portion 1162g are arranged in a U-shape, that is, the middle connection plate 1162c is basically in a U-shaped structure. The second connection portion 1162h is connected to the respective support post 1161a or 1161b, the fourth connection portion 1162j is connected to the respective support post 1161a or 1161b, and the sixth connection portion 1162g is connected to the respective support post 1161a or 1161b. The second connection portion 1162h, the fourth connection portion 1162j, and the seventh connection portion 1162k have a U-shaped structure and are arranged around the surface of the respective support post 1161a or 1161b, which is conducive to improving the connection stability between the respective support post 1161a or 1161b and the control arm connection seat 1162.

A ratio of the area of the second connection portion 1162h to the area of the first side connection plate 1162a is preferably in the range from 0.35 to 0.65, a ratio of the area of the fourth connection portion 1162j to the area of the second side connection plate 1162b is preferably in the range from 0.35 to 0.65, and a ratio of the area of the seventh connection portion 1162k to the area of the middle connection plate 1162c is preferably in the range from 0.2 to 0.4. The above settings can increase the contact area between the first side connection plate 1162a, the second side connection plate 1162b, and the middle connection plate 1162c and the respective support post 1161a or 1161b, and improve the fixing strength between the control arm connection seat 1162 and the respective support post 1161a or 1161b. At the same time, it is necessary to avoid occupying the installation space of the control arms 311 in the control arm connection seat 1162 due to the excessive area of the second connection portion 1162h, the fourth connection portion 1162j, and the seventh connection portion 1162k.

The middle connection plate 1162c further includes a first guide portion 1162m connected to the fifth connection portion 1162f and a second guide portion 1162n connected to the sixth connection portion 1162g. The first guide portion 1162m is inclined towards the direction closer to the first side connection plate 1162a, and the second guide portion 1162n is inclined towards the direction closer to the second side connection plate 1162 b. The first guide portion 1162m and the second guide portion 1162n are used to provide guidance during the installation process of the control arms 311, improving the assembly convenience of the control arms 311 and the control arm connection seat 1162.

A control arm separation distance D5 between the upper and lower control arm connection seats 1162 on each of the right support tube 1161a and the left support tube 1161b is preferably in the range from 70 mm to 130 mm, and more preferably in the range from 80 mm to 120 mm.

The first side connection plate 1162a includes a first reinforcement portion 1162p, which is positioned on the side of the first side connection plate 1162a away from the middle connection plate 1162c. The second side connection plate 1162b includes a second reinforcement portion 1162q, which is positioned on the side of the second side connection plate 1162b away from the middle connection plate 1162c. The first reinforcement part 1162p and the second reinforcement part 1162q can improve the strength of the first side connection plate 1162a and the second side connection plate 1162b, thereby facilitating the overall strength improvement of the control arm connection seat 1162. The first reinforcement portion 1162p and the second reinforcement portion 1162q are preferably reinforcing ribs.

The thickness of the middle connection plate 1162c is preferably less than or equal to the thickness of the first side connection plate 1162a or the second side connection plate 1162b. The U-shape of the middle connection plate 1162c forms the connection space of the associated control arm 311. At the same time, a portion of the first side connection plate 1162a and a portion of the second side connection plate 1162b reinforce both sides of the middle connection plate 1162c. When the thickness of the middle connection plate 1162c is small, it can avoid occupying the connection space of the associated control arm 311 and improve the installation convenience of the associated control arm 311.

As shown in FIGS. 25 and 26, an air conditioner 24 is connected to the front frame 117. The air conditioner 24 includes a compressor 241, an evaporator 242, a heat exchanger 243, and a condenser 244. The condenser 244 is arranged in front of the evaporator 242, the compressor 241 is at least partially arranged between the condenser 244 and the evaporator 242, and the heat exchanger 243 is arranged on one of the two sides of the compressor 241 along the width direction of the off-road vehicle 100. During the operation of the heat exchanger 243, humidity will condense when it comes into contact with the heat exchanger 243. The preferred air conditioner layout helps prevent water droplets on the heat exchanger 243 from falling onto the compressor 241, thereby preventing the compressor 241 from being damaged or causing safety hazards when it encounters water, and thus improving the safety of the air conditioner 24. In addition, preferred air conditioner layout reduces pipeline length of the air conditioner 24 thereby lowering its cost. The compressor 241 is preferably the lowest component of the air conditioner 24, facilitating the return of lubricating oil in the pipeline of the air conditioner 24, thereby lubricating the various components of the air conditioner 24, improving the lubrication effect of each component of the air conditioner 24, improving the service life of the air conditioner 24, and also improving the working stability of the air conditioner 24, thereby improving the performance of the air conditioner 24.

The air conditioner 24 further includes an air conditioning controller 245 mounted on the evaporator 242. Integrating and installing the air conditioning controller 245 on the evaporator 242 improves the space utilization rate of the air conditioner 24 and facilitating the compactness of the air conditioner 24. Optionally, one end of the air conditioning controller 245 is fixedly connected to the evaporator 242, and the other end of the air conditioning controller 245 is clamped to the evaporator 242, thereby facilitating the installation and disassembly of the air conditioning controller 245 and improving its assembly. In addition, the air conditioner 24 further includes an adjustment mechanism 246. The off-road vehicle 100 also includes a cockpit 26 positioned between the front wheels 131 and the rear wheels 132. The adjustment mechanism 246 is arranged on the front side of the cockpit 26, allowing users to adjust the temperature of the air conditioner 24 through the adjustment mechanism 246, thereby improving the comfort and human-machine interaction of the off-road vehicle 100.

The off-road vehicle 100 further comprises a cooling system 25, which includes a radiator 251 arranged on the front side of the frame 11. The condenser 244 is preferably at least partially arranged on the radiator 251. Integrating and installing the condenser 244 on the radiator 251 is beneficial for improving the compactness and space utilization of the air conditioner 24 and the cooling system 25. In addition, the radiator 251 helps dissipate heat from the condenser 244, thereby improving the cooling efficiency of the condenser 244 and further enhancing the working efficiency of the air conditioner 24.

The front frame 117 includes a fixing bracket 1171 and a connection bracket 1172. The fixing bracket 1171 is disposed between the condenser 244 and the compressor 241, and the connecting bracket 1172 is positioned at the forefront of the front frame 117. Among them, the fixing bracket 1171 is connected to the connection bracket 1172, which is arranged in front of the fixing bracket 1171. The compressor 241 is arranged on the fixing bracket 1171, and the radiator 251 is arranged on the fixing bracket 1171. Through the above, the connection stability of the compressor 241, the radiator 251, and the condenser 244 can be improved, so that there will be no displacement during the movement of the off-road vehicle 100, which will affect the normal operation of the air conditioner 24, thereby improving the working stability of the air conditioner 24.

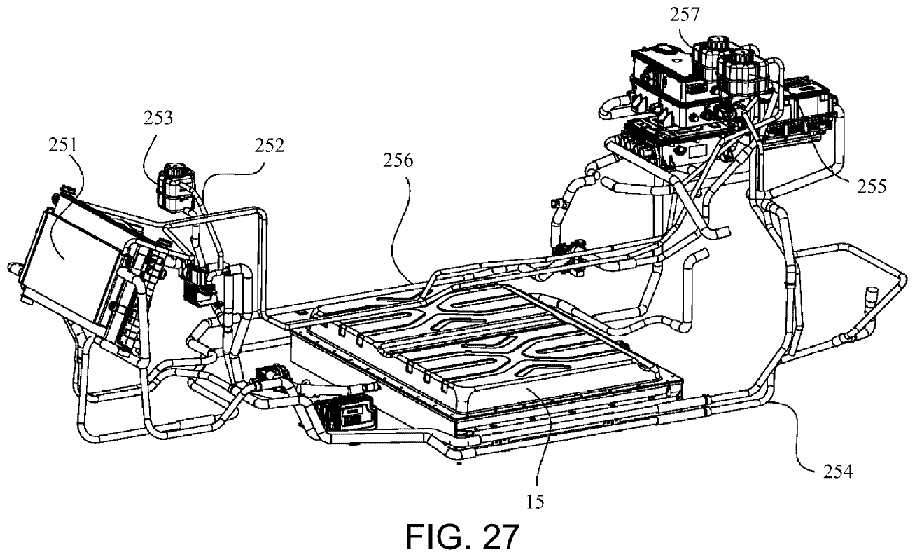

The cooling system 25 includes a battery cooling pipeline 252 and a front coolant tank 253 as shown in FIG. 27. The battery cooling pipeline 252 and the front coolant tank 253 are both mounted on the front frame 117, and the front coolant tank 253, the power battery 15, and the evaporator 242 are connected through the battery cooling pipeline 252. Through the above, the battery cooling pipeline 252 can be placed close to the power battery 15, which can reduce the length of the battery cooling pipeline 252, lower the pipeline cost, and also cool the battery cooling pipeline 252 through the evaporator 242, improve the working efficiency of the battery cooling pipeline 252, and help improve the energy utilization efficiency of the off-road vehicle 100.

The cooling system 25 preferably also includes a range extender cooling pipeline 254 and a rear left coolant tank 255 used for cooling the range extender 142. The rear left coolant tank 255, the radiator 251, and the range extender 142 are connected through the range extender cooling pipeline 254. The rear left coolant tank 255, the range extender cooling pipeline 254 and the range extender 142 form an independent cooling circuit, so that the cooling of the range extender 142 is not affected by other cooling circuits, thereby improving the cooling efficiency of the range extender 142.

The cooling system 25 further includes a drive motor cooling pipeline 256 and a rear right coolant tank 257 for cooling the drive motor 141. The rear right coolant tank 257, the radiator 251, and the drive motor 141 are connected through the drive motor cooling pipeline 256. The rear right coolant tank 257, the drive motor cooling pipeline 256 and the drive motor 141 form an independent cooling circuit, so that the cooling of the drive motor 141 is not affected by other cooling circuits, thereby improving the cooling efficiency of the drive motor 141. In the event of any cooling pipe failure, normal operation of other cooling pipeline circuits will continue, thereby facilitating the modularization of the cooling system 25 and reducing the maintenance cost of the cooling system 25.

The rear coolant tank 255 and the rear right coolant tank 257 are both laterally aligned on the rear side of the frame 11. The rear left coolant tank 255 is positioned on the side near the range extender 142, and the rear right coolant tank 257 is positioned on the side near the drive motor 141, so that the arrangement of the range extender cooling pipeline 254 and the arrangement of the drive motor cooling pipeline 256 do not interfere with each other.

Furthermore, the range extender cooling pipeline 254 and the drive motor cooling pipeline 256 run along right and left sides of the power battery 15. With the range extender 142 on the left side of the off-road vehicle 100 and the drive motor 141 on the right side of the off-road vehicle 100, the range extender cooling pipeline 254 extends longitudinally at least partially along the left side of the frame 11, and the drive motor cooling pipeline 256 extends longitudinally at least partially along the right side of the frame 11. This ensures that the range extender cooling pipeline 254 and the drive motor cooling pipeline 256 do not interfere.

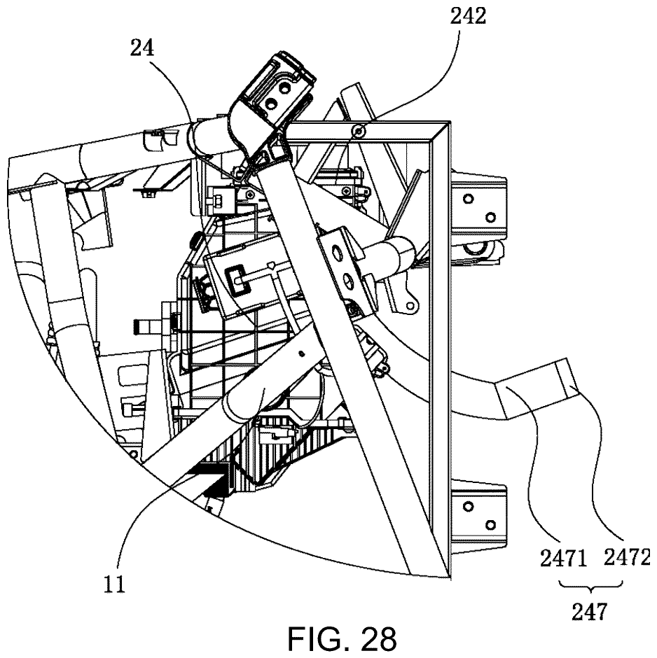

As shown in FIG. 28, the air conditioner 24 includes an air outlet mechanism 247 connected to the evaporator 242. The air outlet mechanism 247 can deliver air cooled by the evaporator 242 to the interior of the off-road vehicle 100. The air outlet mechanism 247 includes an air outlet body 2471 and an air guide cover 2472. The air outlet body 2471 is in the shape of a cylindrical tube, and the air guide cover 2472 is detachably connected to the rear end of the air outlet body 2471. As shown in FIG. 29, side walls of the air outlet body 2471 enclose a receiving space 2471a that can be used for storing items. The receiving space 2471a has a length L10 much greater than its diameter R, so that the receiving space 2471a has a larger accommodating depth, which can facilitate the placement of beverage bottles or cans in the receiving space 2471a. An air outlet receiving space ratio L10/R of the length L10 of the receiving space 2471a to the diameter R of the receiving space 2471a is preferably in the range from 2.2 to 4.3, more preferably in the range from 2.6 to 3.9, and most preferably in the range from 2.9 to 3.6. The preferred values for the air outlet receiving space ratio L10/R allow the air outlet body 2471 to be used as a space for chilled or heated beverages, and use the cold or warm air output from the air outlet mechanism 247 to cool or heat the beverages. The length L10 of the receiving space 2471a is preferably in the range from 140 mm to 260 mm, more preferably in the range from 160 mm to 240 mm and most preferably in the range from 180 mm to 220 mm. The diameter R of the receiving space 2471a is preferably within the range of 40 mm to 90 mm, more preferably within the range from 50 mm to 80 mm, and most preferably within the range from 60 mm to 70 mm. An appropriate length L10 and diameter R of the storage space 2471a can allow most of the beverage bottles and cans on the market to be placed into the receiving space 2471a with at least ⅔ of the beverage bottles or cans positioned in the storage space 2471a, enough to ensure the stability of the entire bottle/can. At the same time, the air outlet body 2471 does not unreasonably intrude into the cockpit 26 or take up too much space at the front of the vehicle 100.

An air outlet incline angle δ is defined between the axis of the air outlet body 2471 and horizontal. The air outlet incline angle δ is preferably in the range from 8.5 to 19.5°, more preferably in the range from 9.5 to 18°, and most preferably in the range from 11 to 16°. If the air outlet incline angle δ is too small, beverage bottles or cans are easily dislodged from the air outlet body 2471 during the driving of the off-road vehicle 100, which affects the driving safety of the off-road vehicle 100. If the air outlet incline angle δ is too large, the air outlet direction of the air outlet mechanism 247 is adversely affected, which can result in the inability to deliver sufficient flow or cold or warm air to the driver and passengers.

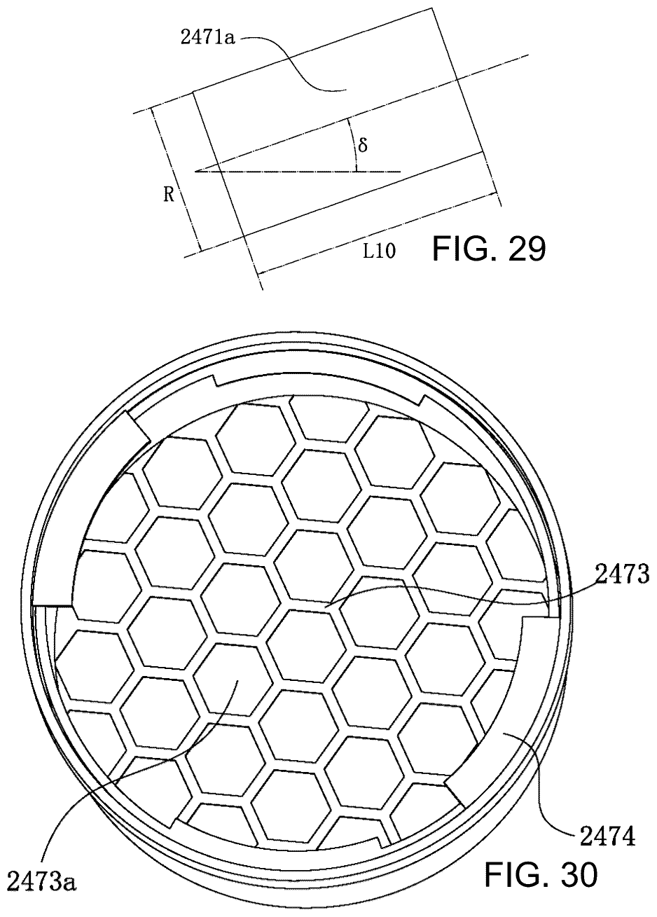

The air outlet mechanism 247 preferably includes a perforated partition wall 2473 as shown in FIG. 30 at the bottom/front end of the air outlet body 2471. Hexagonal holes 2473a through the perforated partition wall 2473 allow delivery of cold and warm air therethrough, and also provide support for a can or bottle placed inside the air outlet body 2471. The holes 2473a in the perforated partition wall 2473 preferably make up 65 to 95% of its area, more preferably making up from 75 to 95% of its area, and .most preferably making up from 85 to 95% of its area. If the holes 2473a are too extensive, the load-bearing capacity of the perforated partition wall 2473 is compromised. If the holes 2473a are too small, the perforated partition wall 2473 will affect the ventilation flow, thereby reducing the cooling or heating effect.

The air guide cover 2472 is detachably connected to the air outlet body 2471 by hand screwing, clamping, or plugging. The hand detachable connection between the air guide cover 2472 and the air outlet can improve the convenience of installation and removal of the air guide cover 2472, facilitating quick installation of the air guide cover 2472 to achieve normal use of the air conditioner 24, and also facilitating quick removal of the air guide cover 2472 to place beverage bottles or cans in the air outlet body 2471 for cooling or heating.

The air outlet mechanism 247 further includes anti slip components 2474, which are positioned on the inner wall of the air outlet body 2471. Installing anti slip components 2474 on the inner wall of the air outlet body 2471 can better enhance the stability of placing beverage bottles and cans in the air outlet body 2471. Optionally, the anti slip component 2474 may be at least one of anti slip pads or anti slip strips.

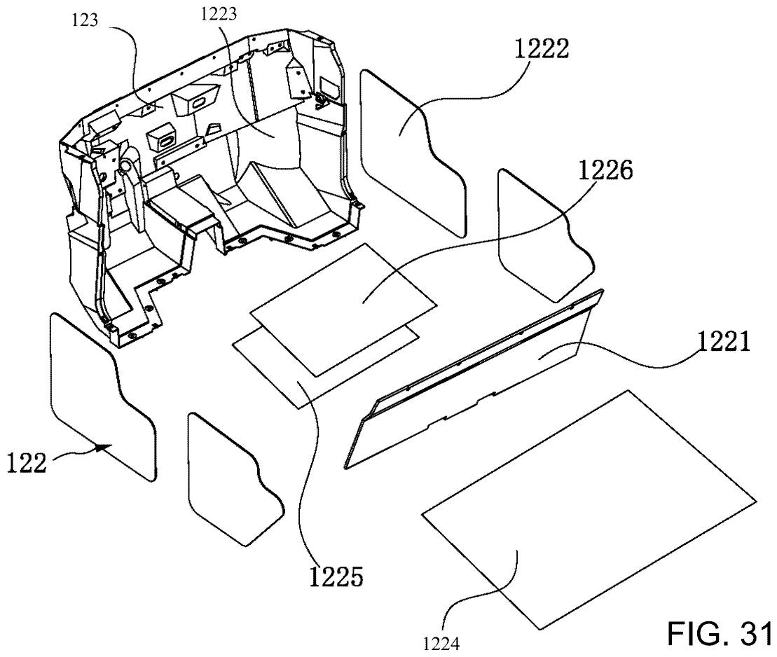

As shown in FIG. 31, the vehicle body cover 12 includes a collection of composite panels 122, which is set as a thermal and/or sound insulation material. More particularly, each of the collection of composite panels 122 is designed as a double-layer plate-like structure with internal honeycomb webbing, so that each of the collection of composite panels 122 can absorb noise and vibration while isolating heat, thereby achieving heat and sound insulation functions while maintaining strength.

The collection of composite panels 122 includes a first composite component 1221 arranged between the seating 17 and the locomotive power system 14. As an alternative embodiment, the first composite component 1221 is at least partially arranged around the range extender 142 and/or the drive motor 141. In front view, the first composite component 1221 preferably overlaps 16 to 31% of the vehicle body cover 12, more preferably overlaps 19 to 27% of the vehicle body cover 12, and most preferably overlaps about 23% of the vehicle body cover 12. a of the backrest projection is in the range from 0.19 to 0.27. By appropriately sizing the first composite component 1221, the first composite component 1221 provides thermal and sound insulation between the cockpit 26 and the locomotive power system 14. The use of other insulation, such as cotton or blown fiberglass insulation, can be reduced. In addition, the first composite component 1221 provides a light weight solution to reduce vibration transmission from the locomotive power system 14 to the seating 17, thereby improving the ride comfort of the off-road vehicle 100.

The off-road vehicle 100 further includes four doors 27 as shown in FIG. 1. The collection of composite panels 122 also includes second composite components 1222, one provided on each door 27. In side view, the second composite components 1222 preferably overlap 19 to 37% of the area of the doors 27, more preferably overlapping 24 to 33% of the area of the doors 27, and most preferably overlapping about 28% of the area of the doors 27. By appropriately sizing the second composite components 1222, noise transmission into the cockpit 26 can be reduced while not overly increasing weight or reducing the overall structural strength of the doors 27.

The vehicle body cover 12 also includes a dashboard control panel 123 positioned in front of the seating 17, which is used to arrange operation buttons or panels for controlling at least some of the electrical system 22. The collection of composite panels 122 also includes a third composite component 1223 arranged on the dashboard control panel 123. In front view, the third composite component 1223 preferably overlaps 27 to 51% of the area of the dashboard control panel 123, more preferably overlapping 32 to 45% of the area of the dashboard control panel 123, and most preferably overlapping about 39% of the area of the dashboard control panel 123. By appropriately sizing the third composite component 1223, noise transmission into the cockpit 26 can be reduced while not overly increasing weight or reducing the overall structural strength of the dashboard control panel 123.

The collection of composite panels 122 also includes a fourth composite component 1224 mounted on the cargo container 18. In plan view, the fourth composite component preferably overlaps from 48 to 91% of the area of the cargo container 18, more preferably overlapping 59 to 81% of the area of the cargo container 18, and most preferably overlapping about 69% of the area of the cargo container 18. By appropriately sizing the fourth composite component 1224, noise and vibration transmission from the locomotive power system 14 can be reduced while not overly increasing weight or reducing the overall structural strength of the cargo container 18.

The collection of composite panels 122 further includes a fifth composite component 1225 arranged on the skidplate 121 and a sixth composite component 1226 arranged on the upper side of the power battery 15. In plan view, a combination of the fifth composite component 1225 and the sixth composite component 1226 is preferably from 66 to 123% as large as the power battery 15, more preferably from 80 to 109% as large as the power battery, and most preferably about 94% as large as the power battery. By appropriately sizing the fifth composite component 1225 and the sixth composite component 1226, the floor of the cockpit 26 can be strengthened while further protecting the power battery 15.

Optionally, the collection of composite panels 122 are at least partially arranged around the off-road vehicle 100, so as to isolate the heat inside and outside the off-road vehicle 100, thereby improving the cooling and heating effects of the air conditioner 24 and further enhancing the comfort of the off-road vehicle 100.

It should be understood that for those skilled in the art, improvements or transformations can be made based on the above description, and all such improvements and transformations should fall within the scope of protection of the claims attached to the present invention.

1. An off-road vehicle comprising:
a frame comprising a rear frame, and the rear frame defining a rear receiving space;
a locomotive power system supported by the frame and being at least partially positioned in the rear receiving space, the locomotive power system comprising an electric drive motor for providing torque and a range extender for outputting electrical energy;
seating mounted on the frame in front of the locomotive power system, the seating comprising front-row seating and rear-row seating, the rear-row seating including a moveable lower backrest; and
wheels supporting the frame and driven by torque from the electric drive motor, the wheels comprising front wheels in front of the seating and rear wheels behind the seating;
wherein the drive motor overlaps at least partially with the range extender in side view, with the drive motor positioned at least partially rearward of the range extender, and wherein the range extender overlaps at partially with the moveable lower backrest in front view, with an amount of front view overlap of the range extender and the moveable lower backrest is in a range from 627 cm² to 941 cm².

2. The off-road vehicle of claim 1, wherein a combined plan view area of the range extender and the drive motor occupies from 26 to 49% of a plan view area of the rear receiving space.

3. The off-road vehicle according to claim 1, wherein the range extender and the drive motor are substantially arranged on opposing right or left sides of a longitudinal mid-plane of the off-road vehicle.

4. The off-road vehicle of claim 3, wherein the off-road vehicle further comprises an air intake system and an exhaust system connected to the range extender, and wherein the range extender comprises a crankshaft extending substantially longitudinally in the off-road vehicle, with the exhaust system positioned on an outside of the off-road vehicle relative to the air intake system.

5. The off-road vehicle of claim 4, wherein the air intake system comprises an air filter at least partially in front of the range extender and behind the lower backrest.

6. The off-road vehicle of claim 1, further comprising a gear reduction unit coupled to the drive motor, wherein the gear reduction unit is at least partially positioned between the drive motor and the range extender.

7. The off-road vehicle of claim 5, further comprising a motor controller, wherein the drive motor, the motor controller and the gear reduction unit are preassembled as a drive combination unit prior to attachment into the rear receiving space.

8. The off-road vehicle of claim 1, wherein the lower backrest has a lower backrest height, wherein the rear-row seating further comprises an upper backrest pivotally attached relative to a seat bottom cushion, the upper backrest having an upper backrest height, and wherein a backrest height ratio of the upper backrest height to the lower backrest height is in the range from 1.8 to 2.6.

9. The off-road vehicle of claim 1, wherein the off-road vehicle further comprises a rear suspension having right and left upper control arms, right and left lower control arms and a knuckle, wherein an inner end of each of the control arms is pivotally connected to a rear control arm support section by a control arm connection seat and an outer end of each of the control arms is pivotally connected to the knuckle, wherein each control arm connection seat comprises first and second connection plates attached around a middle connection plate.

10. The off-road vehicle of claim 1, wherein the off-road vehicle further comprises an air conditioner having an air outlet mechanism, wherein the air outlet mechanism comprises an air outlet body and an air guide cover detachably attachable to the air outlet body, the air outlet body being tubular so as to define a storage space for at least partially receiving a beverage can or bottle.

11. The off-road vehicle of claim 10, wherein the storage space has a length and a diameter, and wherein an air outlet receiving space ratio of the length of the storage space to the diameter of the storage space is in the range from 2.2 to 4.3.

12. The off-road vehicle of claim 11, wherein an air outlet incline angle defined between an axis of the air outlet body and horizontal is in a range from 8.5 to 19.5°.

13. The off-road vehicle of claim 1, further comprising a power battery at least partially below the seating.

14. The off-road vehicle of claim 13, further comprising a front drive shaft delivering torque from the drive motor to the front wheels, wherein the power battery has an upper surface with is generally horizontal but defines a drive shaft avoidance recess, the drive shaft avoidance recess extending under the front drive shaft to avoid interference with the front drive shaft.

15. The off-road vehicle of claim 13, further comprising a cooling system, the cooling system comprising:
a range extender cooling pipeline for cooling the range extender; and
a drive motor cooling pipeline for cooling the drive motor, the drive motor cooling pipeline being independent from the range extender cooling pipeline;
wherein the range extender cooling pipeline and the drive motor cooling pipeline extend longitudinally on opposing right and left sides of the power battery.

16. The off-road vehicle of claim 13, wherein a wheelbase is defined as a longitudinal distance between an axis of the front wheels and an axis of the rear wheels, wherein the power battery has a power battery length, wherein a longitudinal distance between the axis of the front wheels and a front-most end of the power battery is defined as a front axis-battery gap, wherein a longitudinal distance between a rear-most end of the power battery and the axis of the rear wheels is defined as a battery-rear axis gap, wherein the power battery length is in a range of 17 to 34% of the wheelbase, and wherein a battery gap ratio of the front axis-battery gap to the battery-rear axis gap is in a range from 0.61 to 1.14.

17. An off-road vehicle comprising:
a frame having a longitudinal mid-plane, the frame comprising a rear frame which defines a rear receiving space;
a locomotive power system supported by the frame and being at least partially positioned in the rear receiving space, the locomotive power system comprising an electric drive motor for providing torque and a range extender for outputting electrical energy;
seating mounted on the frame in front of the locomotive power system; and
wheels supporting the frame and driven by torque from the electric drive motor, the wheels comprising front wheels in front of the seating and rear wheels behind the seating;
wherein the drive motor overlaps at least partially with the range extender in side view, with the drive motor positioned at least partially rearward of the range extender, and wherein the range extender and the drive motor are substantially arranged on opposing right or left sides of the longitudinal mid-plane of the off-road vehicle.

18. The off-road vehicle of claim 17, wherein the off-road vehicle further comprises an air conditioner having an air outlet mechanism, and wherein the air outlet mechanism comprises an air outlet body and an air guide cover detachably attachable to the air outlet body, the air outlet body being tubular so as to define a storage space for at least partially receiving a beverage can or bottle, wherein an air outlet incline angle defined between an axis of the air outlet body and horizontal is in a range from 8.5 to 19.5°.

19. The off-road vehicle of claim 17, further comprising a power battery at least partially below the seating and a front drive shaft delivering torque from the drive motor to the front wheels, wherein the power battery has an upper surface with is generally horizontal but defines a drive shaft avoidance recess, the drive shaft avoidance recess extending under the front drive shaft to avoid interference with the front drive shaft.

20. An off-road vehicle comprising:
a frame comprising a rear frame which defines a rear receiving space;
a locomotive power system supported by the frame and being at least partially positioned in the rear receiving space, the locomotive power system comprising an electric drive motor for providing torque and a range extender for outputting electrical energy;
seating mounted on the frame in front of the locomotive power system;
wheels supporting the frame and driven by torque from the electric drive motor, the wheels comprising front wheels in front of the seating and rear wheels behind the seating, with a wheelbase defined as a longitudinal distance between an axis of the front wheels and an axis of the rear wheels; and
a power battery having a power battery length, wherein a longitudinal distance between the axis of the front wheels and a front-most end of the power battery is defined as a front axis-battery gap, wherein a longitudinal distance between a rear-most end of the power battery and the axis of the rear wheels is defined as a battery-rear axis gap, wherein the power battery length is in a range of 17 to 34% of the wheelbase, and wherein a battery gap ratio of the front axis-battery gap to the battery-rear axis gap is in a range from 0.61 to 1.14;
wherein the drive motor overlaps at least partially with the range extender in side view, with the drive motor positioned at least partially rearward of the range extender.
